(19) United States
(12) Patent Application Publication
(10) Pub. No.: US 2026/0275992 A1
(43) Pub. Date: Sep. 17, 2026

(54) PORTABLE FAN

(71) Applicant: SHENZHEN JISU TECHNOLOGY CO., LTD, SHENZHEN (CN)

(72) Inventors: GUANZHENG ZHENG, SHENZHEN (CN); SHUIYONG YUAN, SHENZHEN (CN); HAIJUN GAO, SHENZHEN (CN)

(21) Appl. No.: 19/670,527

(22) Filed: May 7, 2026

Related U.S. Application Data
(63) Continuation of application No. 19/095,179, filed on Mar. 31, 2025.
Application No. 19/095,179 is a continuation of application No. PCT/CN2023/125354, filed on Oct. 19, 2023.

(51) Int. Cl. F04D 25/08; F04D 19/00; F04D 25/06; F04D 29/52

(52) U.S. Cl. CPC F04D 25/084; F04D 19/002; F04D 25/0673; F04D 25/068; F04D 25/0693; F04D 29/522

(57) ABSTRACT

A portable fan includes an airflow portion including an outer shell and a first inner shell received in the outer shell. A fan base and air outlet portion are arranged inside the first inner shell, and the air outlet portion is arranged between the fan base and the first inner shell, the fan base defining a first side and an opposite second side thereof, the first side facing towards an air inlet, the second side facing towards an air outlet, and the air outlet is in communication with the air outlet portion; and a fan impeller is connected to the first side of the fan base, a display screen is connected to the second side of the fan base, and a diameter of the display screen is greater than a distance between the outer side of the fan base and the inner side of the first inner shell.

### CROSS REFERENCE TO RELATED APPLICATIONS

This application is a continuation application of U.S. Pat. No. 19,095,179, filed on Mar. 31, 2025, and entitled “PORTABLE FAN”, now pending; and the U.S. Pat. No. 19,095,179 is a continuation application of the international patent application No. PCT/CN2023/125354, filed on Oct. 19, 2023, which claims the priority of: the Chinese patent application No. 202223449516.3, filed on Dec. 21, 2022; the Chinese patent application No. 202320027723.5, filed on Jan. 4, 2023; the Chinese patent application No. 202321571278.5, filed on Jun. 19, 2023; the Chinese patent application No 202321571290.6, filed on Jun. 19, 2023; the Chinese patent application No 202321571402.8, filed on Jun. 19, 2023; the Chinese patent application No. 202321574046.5, filed on Jun. 19, 2023; the Chinese patent application No. 202321574061.X, filed on Jun. 19, 2023; the Chinese patent application No. 202321575893.3, filed on Jun. 19, 2023; the Chinese patent application No. 202321575918.X, filed on Jun. 19, 2023; the Chinese patent application No. 202321578720.7, filed on Jun. 19, 2023; the Chinese patent application No. 202321578817.8, filed on Jun. 19, 2023; the Chinese patent application No. 202321579734.0, filed on Jun. 19, 2023; the Chinese patent application No. 202321581200.1, filed on Jun. 19, 2023; the Chinese patent application No. 202321582143.9, filed on Jun. 19, 2023; the Chinese patent application No. 202321582170.6, filed on Jun. 19, 2023; the Chinese patent application No. 202321961287.5, filed on Jul. 24, 2023; the Chinese patent application No. 202321965090.9, filed on Jul. 24, 2023; the Chinese patent application No. 202321972292.6, filed on Jul. 24, 2023; the Chinese patent application No. 202322101304.4, filed on Aug. 4, 2023; and contents of which are incorporated herein by its entireties.

### TECHNICAL FIELD

Embodiments of the present disclosure relate to the technical field of fans, and more specifically, to a portable fan.

### BACKGROUND

A portable fan that is commonly used in the art is assembled by splicing a front shell and a rear shell. When the portable fan malfunctions, the battery may not be replaced easily. Maintenance may not be performed easily, and a battery life may be poor.

### SUMMARY

The present disclosure provides a portable fan, including an airflow portion including an outer shell and a first inner shell received in the outer shell. Wherein a fan base and air outlet portion are arranged inside the first inner shell, and the air outlet portion is arranged between an outer side of the fan base and an inner side of the first inner shell, the fan base defining a first side and an opposite second side thereof, the first side facing towards an air inlet, the second side facing towards an air outlet, and the air outlet is in communication with the air outlet portion; and wherein a fan impeller is connected to the first side of the fan base, a display screen is connected to the second side of the fan base, and a diameter of the display screen is greater than a distance between the outer side of the fan base and the inner side of the first inner shell.

### BRIEF DESCRIPTION OF THE DRAWINGS

FIG. 1-1 is a perspective view of a portable fan according to an embodiment of the present disclosure.

FIG. 1-2 is an exploded view of the portable fan shown in FIG. 1-1.

FIG. 1-3 is an exploded view of the portable fan shown in FIG. 1-2, where a sleeve is omitted.

FIG. 1-4 is a structural schematic view of a fan base of the portable fan according to an embodiment of the present disclosure.

FIG. 1-5 is a structural schematic view of a pressurizing seat of the portable fan according to an embodiment of the present disclosure.

FIG. 1-6 is a structural schematic view of the sleeve of the portable fan according to an embodiment of the present disclosure.

FIG. 2-1 is a perspective view of a portable fan according to a first embodiment of the present disclosure.

FIG. 2-2 is a cross-sectional view of the portable fan of the first embodiment of the present disclosure.

FIG. 2-3 is an enlarged view of a portion A in FIG. 2-2.

FIG. 2-4 is a cross-sectional view of the portable fan of the first embodiment of the present disclosure.

FIG. 2-5 is a cross-sectional view of the portable fan according to a second embodiment of the present disclosure.

FIG. 2-6 is a cross-sectional view of the portable fan according to a third embodiment of the present disclosure.

FIG. 3-1 is a structural schematic view of an airflow portion according to an embodiment 3-1 of the present disclosure.

FIG. 3-2 is an exploded view of the airflow portion according to the embodiment 3-1 of the present disclosure.

FIG. 3-3 is a cross-sectional view of the airflow portion according to the embodiment 3-1 of the present disclosure.

FIG. 3-4 is a structural schematic view of a display screen according to an embodiment of the present disclosure.

FIG. 3-5 is a structural schematic view of an inner shell that is assembled according to an embodiment of the present disclosure.

FIG. 3-6 is a structural schematic view of the portable fan according to an embodiment 3-2 of the present disclosure.

FIG. 3-7 is a cross-sectional view of the portable fan in the embodiment 3-2.

FIG. 4-1 is a structural schematic view of a handheld according to an embodiment of the present disclosure.

FIG. 4-2 is a structural schematic view of a mounting bracket in the handheld fan according to an embodiment of the present disclosure.

FIG. 4-3 is a structural schematic view of a handheld shell of the handheld fan according to an embodiment of the present disclosure.

FIG. 4-4 is a structural schematic view of a control mechanism in the handheld fan according to an embodiment of the present disclosure.

FIG. 4-5 is a structural schematic view of a mounting groove in the handheld fan according to an embodiment of the present disclosure.

FIG. 4-6 is a structural schematic view of an outer shell of the handheld fan according to an embodiment of the present disclosure.

FIG. 4-7 is a structural schematic view of a first circuit board in the handheld fan according to an embodiment of the present disclosure.

FIG. 4-8 is a structural schematic view of an inner shell in the handheld fan according to an embodiment of the present disclosure.

FIG. 5-1 is a structural schematic view of an airflow component of a handheld fan according to an embodiment of the present disclosure.

FIG. 5-2 is a structural schematic view of a mounting bracket in the airflow component of the handheld fan according to an embodiment of the present disclosure.

FIG. 5-3 is a structural schematic view of a handheld portion in the airflow component of the handheld fan according to an embodiment of the present disclosure.

FIG. 5-4 is a structural schematic view of a wire opening in the airflow component of the handheld fan according to an embodiment of the present disclosure.

FIG. 5-5 is a structural schematic view of a wire receiving groove in the airflow component of the handheld fan according to an embodiment of the present disclosure.

FIG. 5-6 is a structural schematic view of the wire receiving groove in the airflow component of the handheld fan according to an embodiment of the present disclosure.

FIG. 5-7 is a structural schematic view of a gear knob assembly and a protective switch button assembly in the airflow component of the handheld fan according to an embodiment of the present disclosure.

FIG. 5-8 is a structural schematic view of an inner shell and an outer shell of the airflow component of the handheld fan according to an embodiment of the present disclosure.

FIG. 5-9 is a structural schematic view of an air inlet and an air outlet of the airflow component of the handheld fan according to an embodiment of the present disclosure.

FIG. 5-10 is an enlarged view of a portion B in FIG. 5-9.

FIG. 5-11 is a structural schematic view of a fan assembly of the airflow component of the handheld fan according to an embodiment of the present disclosure.

FIG. 6-1 is a structural schematic view of an airflow mechanism of the handheld fan according to an embodiment of the present disclosure.

FIG. 6-2 is a structural schematic view of a shell and a support bracket of the airflow mechanism of the handheld fan according to an embodiment of the present disclosure.

FIG. 6-3 is a structural schematic view of a limiting strip in the airflow mechanism of the handheld fan according to an embodiment of the present disclosure.

FIG. 6-4 is a structural schematic view of the air outlet in the airflow mechanism of the handheld fan according to an embodiment of the present disclosure.

FIG. 6-5 is a structural schematic view of the air inlet in the airflow mechanism of the handheld fan according to an embodiment of the present disclosure.

FIG. 6-6 is a structural schematic view of a sleeve and an air inlet cover in the airflow mechanism of the handheld fan according to an embodiment of the present disclosure.

FIG. 7-1 is a structural schematic view of a handheld fan according to an embodiment of the present disclosure.

FIG. 7-2 is an exploded view of the handheld fan according to an embodiment of the present disclosure.

FIG. 7-3 is a structural schematic view of the air inlet cover according to an embodiment of the present disclosure.

FIG. 7-4 is a structural schematic view of formation of an air duct according to an embodiment of the present disclosure.

FIG. 7-5 is a structural schematic view of fan blades according to an embodiment of the present disclosure.

FIG. 7-6 is a bottom view of the airflow portion according to an embodiment of the present disclosure.

FIG. 7-7 is a structural schematic view of a motor shaft and fan blades being integrally formed according to an embodiment of the present disclosure.

FIG. 7-8 is a structural schematic view of a vibration damping spring according to an embodiment of the present disclosure.

FIG. 7-9 is a structural schematic view of the handheld portion and the airflow portion according to an embodiment of the present disclosure.

FIG. 8-1 is a perspective view of the handheld fan according to an embodiment of the present disclosure.

FIG. 8-2 is an exploded view of the handheld fan according to an embodiment of the present disclosure.

FIG. 8-3 is a perspective view of the air inlet cover of the handheld fan according to an embodiment of the present disclosure.

FIG. 8-4 is a cross-sectional view of the handheld fan, taken along a line A-A, according to an embodiment of the present disclosure.

FIG. 8-5 is a perspective view of the airflow assembly of the handheld fan according to an embodiment of the present disclosure.

FIG. 8-6 is a perspective view of the airflow assembly of the handheld fan according to another embodiment of the present disclosure.

FIG. 9-1 is a perspective view of a handheld fan according to an embodiment of the present disclosure.

FIG. 9-2 is a cross-sectional view of the handheld fan, taken along a line A-A, according to an embodiment of the present disclosure.

FIG. 9-3 is another perspective view of the handheld fan according to an embodiment of the present disclosure.

FIG. 9-4 is a perspective view of the air inlet cover of the handheld fan according to an embodiment of the present disclosure.

FIG. 9-5 is a perspective view of a first side wall of the handheld fan according to an embodiment of the present disclosure.

FIG. 10-1 is a perspective view of a handheld fan according to an embodiment of the present disclosure.

FIG. 10-2 is an exploded view of the handheld fan according to an embodiment of the present disclosure.

FIG. 10-3 is an exploded perspective view of the airflow portion of the handheld fan according to an embodiment of the present disclosure.

FIG. 10-4 is a schematic view of wire arrangement in the handheld fan according to an embodiment of the present disclosure.

FIG. 10-5 is another perspective view of the handheld fan according to an embodiment of the present disclosure.

FIG. 10-6 is a cross-sectional view of the handheld fan according to an embodiment of the present disclosure.

FIG. 10-7 is a front view of the handheld fan according to an embodiment of the present disclosure.

FIG. 10-8 is an enlarged view of part of FIG. 10-6.

FIG. 11-1 is a schematic view of a handheld fan according to an embodiment of the present disclosure.

FIG. 11-2 is an exploded view of the handheld fan according to an embodiment of the present disclosure.

FIG. 11-3 is a schematic view of the airflow portion according to an embodiment of the present disclosure.

FIG. 11-4 is a cross-sectional view of the handheld fan according to an embodiment of the present disclosure.

FIG. 11-5 is a schematic view of the airflow assembly according to an embodiment of the present disclosure.

FIG. 11-6 is a schematic view of an impeller assembly according to an embodiment of the present disclosure.

FIG. 11-7 is a schematic view of connection between the handheld portion and the airflow portion according to an embodiment of the present disclosure.

FIG. 12-1 is a perspective view of a handheld fan according to an embodiment of the present disclosure.

FIG. 12-2 is an exploded view of the handheld fan according to an embodiment of the present disclosure.

FIG. 12-3 is an exploded view of the airflow portion of the handheld fan according to an embodiment of the present disclosure.

FIG. 12-4 is another perspective view of the handheld fan according to an embodiment of the present disclosure.

FIG. 12-5 is a schematic view of wire arrangement in the handheld fan according to an embodiment of the present disclosure.

FIG. 12-6 is a cross-sectional view of the handheld fan according to an embodiment of the present disclosure.

FIG. 12-7 is a front view of the handheld fan according to an embodiment of the present disclosure.

FIG. 12-8 is an enlarged view of part of FIG. 12-6.

### DETAILED DESCRIPTIONS

To facilitate understanding of the present disclosure, the present disclosure will be described in more detail in the following by referring to the accompanying drawings. The drawings show embodiments of the present disclosure. However, the present disclosure can be implemented in various forms and is not limited to the embodiments described herein. On the contrary, the purpose of providing these embodiments is to enable the present disclosure to be understood more thoroughly and comprehensively.

In the description of the present disclosure, terms “front”, “rear”, “top”, “inner”, “outer”, and so on, indicate an orientation or a positional relationship based on an orientation or a positional relationship shown in the drawings. The terms are used only for describing the present disclosure more simply, and do not indicate or imply that a device or an element must have a specific orientation or configured and operated in a specific orientation. Therefore, the terms shall not be interpreted as limiting the present disclosure.

In the description of the present disclosure, unless otherwise specified, “/” means “or”. For example, A/B can mean A or B; the “and/or” in the text is only a description of an associated relationship of associated objects, indicating that three relationships may exist. For example, A and/or B may mean that A is present alone, A and B are both present, or B is present alone. In addition, in the description of the present disclosure, “a plurality of” means two or more than two. It should be understood that preferred embodiments described herein are only for illustrating and explaining the present disclosure, and are not intended to limit the present disclosure. In addition, features of the embodiments of the present disclosure can be combined with each other without conflict.

It should be understood that although terms “first”, “second”, and so on, may be used herein to describe various elements, components, regions, layers, and/or sections, these elements, components, regions, layers, and/or sections shall not be limited by the terms. The terms are used only to distinguish one element, component, region, layer, or section from another element, component, region, layer, or section. Therefore, without departing from the present disclosure, a first element, a first component, a first region, a first layer, or a first section discussed below may be referred to as a second element, a second component, a second region, a second layer, or a second section. Spatially relative terms such as “below”, “above”, and so on, may be used herein to describe a relationship between one element or feature and another element or feature. It should be understood that, in addition to the orientation shown in the drawings, the spatially relative terms also include various orientations of the device while being in use or in operation. For example, when a device in the drawing is flipped, an element or a feature described as being “below” another element or feature may be oriented to be “above” the another element or feature. Therefore, the term “below” may include both “above” and “below”. The device can be oriented (rotated 90 degrees or in other directions), and the spatially relative description used herein are interpreted accordingly. In the present disclosure, description based on the “first”, the “second”, and so on, is only for the purpose of description, and shall not be understood as indicating or implying relative importance or implicitly indicating the number of technical features indicated. It should be noted that when an element is considered to be “connected” to another element, the element can be directly connected to the other element, or an intermediate element may be arranged between the two elements.

Furthermore, when an assembly is considered to be “fixed” to another assembly, the assembly can be directly fixed to the another assembly, or an intermediate between two assemblies. When an element is considered to be “connected” to another element, the element can be directly connected to the other element, or an intermediate element may be arranged between the two elements. When an assembly is considered to be “arranged” on another assembly, the assembly can be directly arranged on the another assembly, or an intermediate assembly may be disposed between two assemblies. The term “vertical”, “horizontal”, “left”, “right”, and similar expressions used in the embodiments are only for the purpose of description and are not intended to limit the present disclosure.

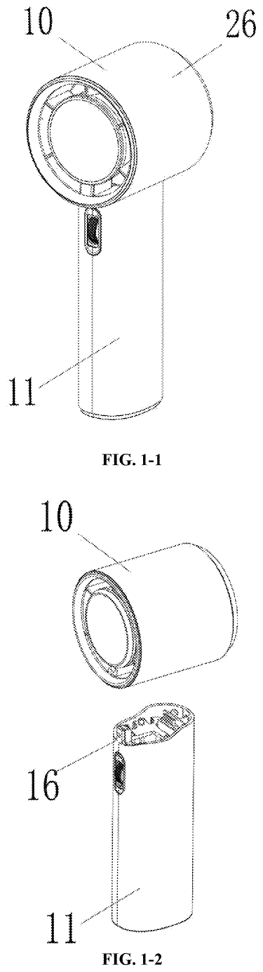

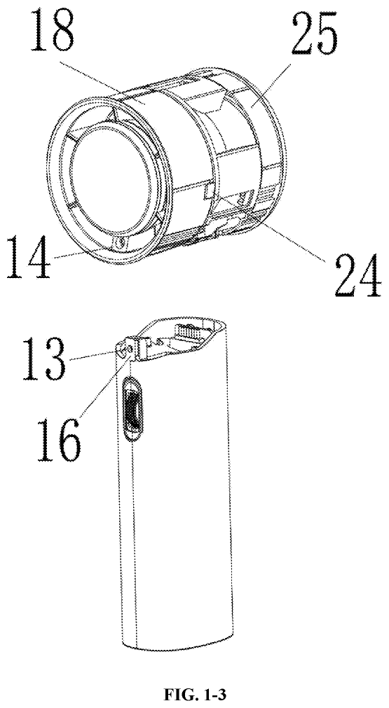

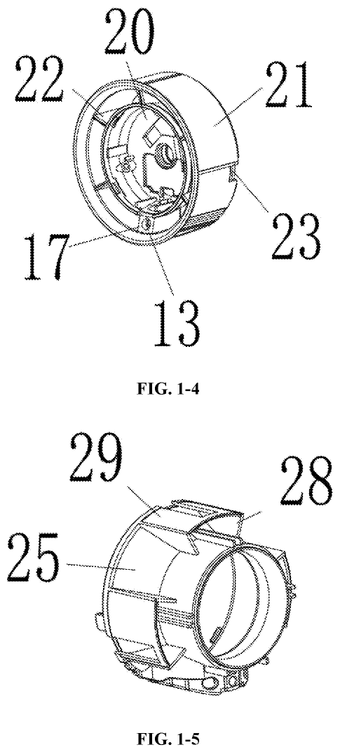

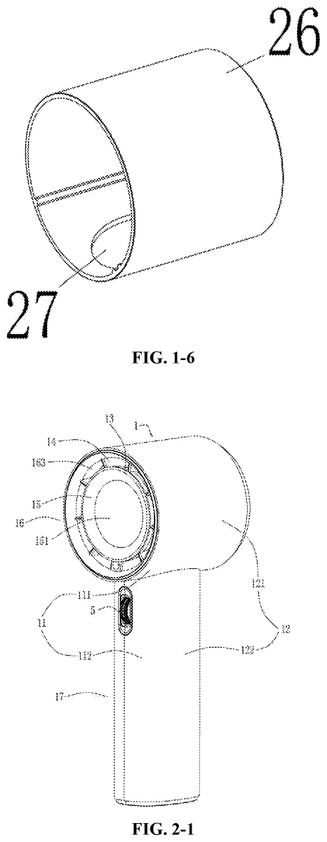

Embodiment 1, referring to FIGS. 1-1 to 1-6:

As shown in FIG. 1-1, in the present embodiment, the portable fan 100 is a handheld fan arranged with a handheld portion 11 (not labeled). A user may carry the portable fan 100 by holding the handheld portion 11. Of course, the portable fan 100 may be a clipped fan arranged with a clip, a variable fan arranged with a bendable shaping member for winding, a desktop fan arranged with a stand, or a floor fan arranged with an extendable and retractable stand. A specific type of the portable fan is not limited herein. The handheld portion 11 may be arranged with a semiconductor cooling element (not shown). When the user is carrying the portable fan 100, the semiconductor cooling element may automatically adjust a cooling temperature based on a temperature of a position where the user contacts the portable fan, improving the usage experience. It should be understood that the portable fan 100 is used for heat dissipation and cooling, and the semiconductor cooling element is arranged to improve the usage experience. Of course, a heating element (not shown) may further be arranged on the portable fan 100 for warming the user, and a warming element (not shown) may be provided accordingly to automatically adjust the temperature for the position where the user contacts the portable fan. In this way, a contact body portion can be warmed, and the usage experience is improved.

As shown in FIG. 1-1, in the present embodiment, the handheld portion 11 may receive a battery (not labeled) therein. The handheld portion 11 may be arranged with a switch button (not labeled) and a charging port (not show) that are exposed to an outside. The battery supplies power to the portable fan 100, the switch button is used to adjust an air speed and to turn on/off the portable fan. The charging port is used to connect to an external power source to charge the battery. When the portable fan 100 is in other forms (such as the above-mentioned clipped fan, the variable fan, the desktop fan, and so on), positions where the battery, the switch button, and the charging port are arranged may be adjusted accordingly.

As shown in FIGS. 1-1 to 1-6, the portable fan 100 includes an airflow portion 10 and the handheld portion 11. The airflow portion 10 and the handheld portion 11 are connected to each other via a fixing member 12. The handheld portion 11 is arranged with a first connecting member 13, and the airflow portion 10 is arranged with a second connecting member 14. The fixing member 12 passes through the first connecting member 13 and the second connecting member 14 to connect the airflow portion 10 with the handheld portion 11. An end of the handheld portion 11 is arranged with a protrusion 16, the protrusion 16 extends along a length direction of the handheld portion 11 and is inserted into the airflow portion 10. The protrusion 16 is arranged with the first connecting member 13. The airflow portion 10 is arranged with a limiting plate 17, and the limiting plate 17 is arranged with the second connecting member 14. The fixing member 12 passes through the first connecting member 13 and the second connecting member 14 to connect the handheld portion 11 with the airflow portion 10. When the handheld portion 11 malfunctions or the battery inside the handheld portion 11 is out of power, the handheld portion 11 alone may be replaced. The replaced handheld portion 11 may be repaired or charged, and a properly-operating handheld portion 11 or a handheld portion 11 having sufficient power may be assembled, such that the battery life is improved.

As shown in FIGS. 1-1 to 1-3, a part of the handheld portion 11 is embedded in the airflow portion 10, or a part of the airflow portion 10 is embedded in the handheld portion 11. The embedding or insertion configuration enhances connection stability between the handheld portion 11 and the airflow portion 10, preventing displacement.

As shown in FIGS. 1-4 to 1-5, the airflow portion 10 includes a fan base 18, a mixed-flow fan 19 arranged on the fan base 18, and a pressurizing seat 25 covering the mixed-flow fan 19. The mixed-flow fan 19 is disposed at a front side of the fan base 18 and rotates around an axis to generate airflow. The pressurizing seat 25 is disposed at a front side of the mixed-flow fan 19 and has a pressurizing surface. A radial size of the pressurizing surface gradually increases along a direction from an end away from the fan base 18 to an end near the fan base 18.

As shown in FIGS. 1-4, the fan base 18 includes an inner ring 20, an outer ring 21, and a plurality of connecting bars 22 connecting the inner ring 20 with the outer ring 21. The inner ring 20 and the outer ring 21 are connected to each other via the plurality of connecting bars 22. The limiting plate 17 is connected between every two connecting bars 22. The limiting plate 17 is arranged with the second connecting member 14. During assembling, the protrusion 16 is inserted between two connecting bars 22 to limit a circumferential displacement of the fan base 18. The first connecting member 13 on the protrusion 16 is aligned with the second connecting member 14 on the limiting plate. The fixing member 12 connects the protrusion 16 with the limiting plate 17 to limit the fan base 18 from moving along an axial direction. In this way, a fixing effect is achieved. It is understood that the fixing member 12 may be a screw, a pin, or glue, as long as the fixing member 12 can fix the protrusion 16 with the limiting plate 17.

In another embodiment, one of the first connecting member 13 and the second connecting member 14 is a connecting slot 23, and the other one of the first connecting member 13 and the second connecting member 14 is a connecting snap 24. The connecting slot 23 and the connecting snap 24 may be configured as any commonly used connecting slot and connecting snap. The handheld portion 11 and the airflow portion 10 are connected to each other via the connecting slot 23 and the connecting snap 24, allowing the assembling to be performed quickly.

As shown in FIGS. 1-4 to 1-5, an outer wall surface of the outer ring 21 of the fan base 18 near the pressurizing seat 25 defines the connecting slot 23, and an end of the pressurizing seat 25 near the fan base 18 is arranged with the connecting snap 24. The pressurizing seat 25 is connected to the fan base 18, such that the assembling is performed conveniently and efficiently.

As shown in FIGS. 1-1 to 1-6, a battery and a circuit board are arranged inside the handheld portion 11. The battery is electrically connected to the circuit board via a wire to control the mixed-flow fan 19 to start rotating.

As shown in FIGS. 1-3 and 1-6, the airflow portion 10 further includes a sleeve 26. The pressurizing seat 25, the fan base 18, and the mixed-flow fan 19 are mounted inside the sleeve 26, such that the pressurizing seat 25, the fan base 18, and the mixed-flow fan 19 are limited from moving along a radial direction of the sleeve 26 but are allowed to move along only an axial direction thereof at openings of two ends of the sleeve 26. In this way, displacement is prevented, and internal structures are protected.

As shown in FIG. 1-6, a side wall of the sleeve 26 defines an assembly port 27 for the protrusion 16 to pass through. The assembly port 27 is defined to allow the protrusion 16 to pass through.

As shown in FIG. 1-5, an outer side wall of the pressurizing seat 25 is arranged with support columns 28. Two support columns 28 extend along a radial direction of the pressurizing seat 25 and are connected to each other via an arc plate 29. Ends of the two support columns 28 are connected to each other via the arc plate 29. The two support columns 28 and the arc plate 29 support an inner wall of the sleeve 26, preventing the sleeve 26 from being collapsed under an external pressure and preventing the pressurizing seat 25 from being deformed due to being pulled downward by the handheld portion 11, such that an inner wall of the pressurizing seat 25 is prevented from touching fan blades, and malfunction can be avoided.

The portable fan further includes a three-phase high-speed motor, such that when the portable fan is operating at high rotation speeds and high energy consumption, a battery life can be improved by replacing the handheld portion and/or replacing the battery inside the handheld portion.

Embodiment 2, referring to FIGS. 2-1 to 2-6:

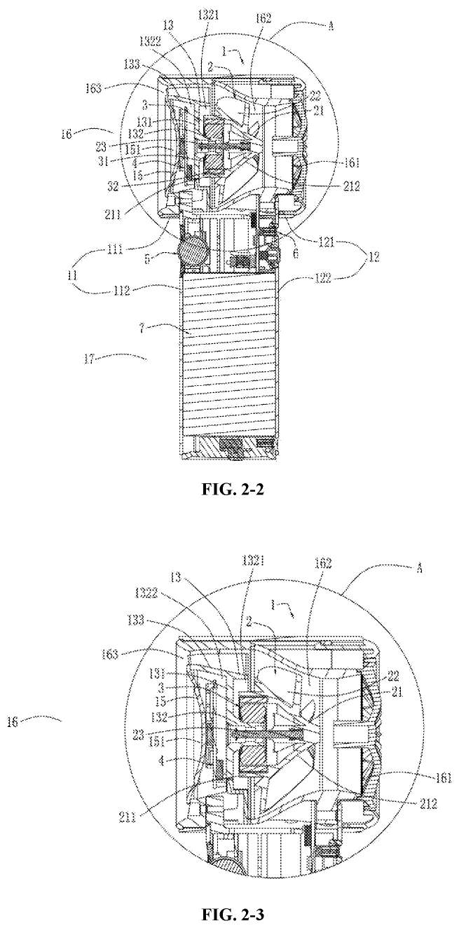

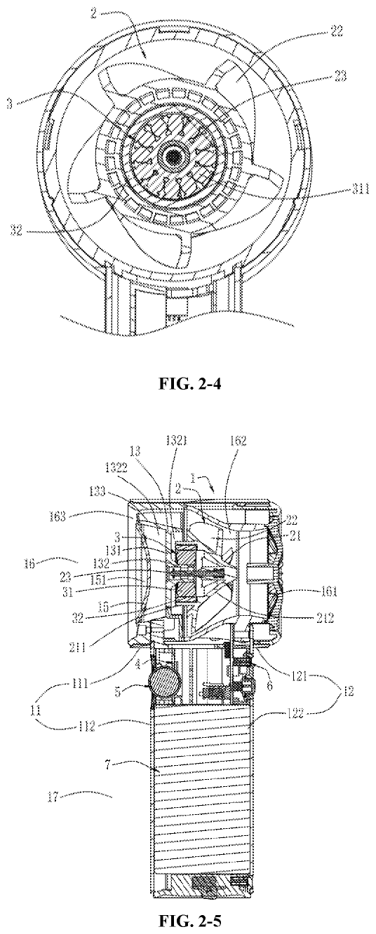

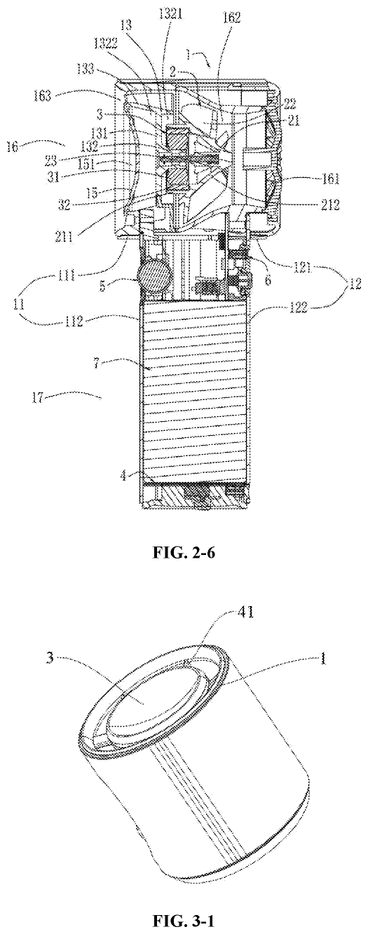

As shown in FIGS. 2-1 and 2-2, the portable fan includes a housing 1, a fan assembly 2, a motor 3, and a drive circuit board 4. The housing 1 defines an air inlet 161, a receiving cavity 162, and an air outlet 163, where the air inlet 161, the receiving cavity 162, and the air outlet 163 are communicated with each other. The fan assembly 2, the motor 3, and the drive circuit board 4 are arranged inside the housing 1. The drive circuit board 4 is electrically connected to the motor 3 to drive the fan assembly 2 to rotate to drive the airflow to flow from the air inlet 161, flowing through the receiving cavity 162, to be discharged out through the air outlet 163.

As shown in FIGS. 2-1 and 2-2, the housing 1 includes a front housing 11 and a rear housing 12. The front housing 11 includes a first airflow housing 111 and a first handheld housing 112, the rear housing 12 includes a second airflow housing 121 and a second handheld housing 122. The first airflow housing 111 and the second airflow housing 121 cooperatively define an air outlet portion 16. The first handheld housing 112 and the second handheld housing 122 cooperatively form a handheld portion 17. It is understood that the first airflow housing 111 and the second airflow housing 121 may be connected to each other in a front-rear direction or in a left-right direction. The first handheld housing 112 and the second handheld housing 122 may be connected to each other in the front-back direction or in the left-right direction. The handheld portion 17 is arranged with a switch 5, an interface 6, and a battery 7. In the present embodiment, the switch 5 is an infinite speed adjustment switch 5. Of course, in other embodiments, the first handheld housing 112 and the second handheld housing 122 may be omitted. Alternatively, the fan may be a desktop fan, a neck fan, a clip fan, a stand fan, or fans in other common forms.

As shown in FIGS. 2-2 to 2-4, the first airflow housing 111 includes a first outer housing and a first inner housing mating with the first outer housing in an inner-outer direction. The first inner housing and the first outer housing may be attached to each other. The first inner housing and the first outer housing both extend horizontally towards the front. The second airflow housing 121 includes a second outer housing and a second inner housing mating with the second outer housing in the inner-outer direction. A rear end of the second inner housing and a rear end of the second outer housing are spaced apart from each other and are connected to each other via a connection member. The second outer housing extend horizontally towards the front. The second inner housing extend firstly horizontally from the rear towards the front, and subsequently, extend outwardly in a radial direction. A front end of the second inner housing is connected to a front end of the second outer housing. The front end of the second inner housing abuts against the rear end of the first inner housing. In the present embodiment, the first outer housing and the second outer housing are integrally molded to form a one-piece structure. In other embodiments, the first outer housing and the second outer housing may be separately molded. Each of the first airflow housing 111 and the second airflow housing 121 is a double-layered housing. Therefore, a more stable structure is provided. A change in a shape of the second inner housing enables the airflow to be pressurized, such that the airflow is stronger, and an air flowing distance is longer. Of course, in other embodiments, the first airflow housing 111 and/or the second airflow housing 121 may be a single-layered housing 1.

As shown in FIGS. 2-1 and 2-2, the housing 1 further includes a pressurizing member 13 arranged inside the first airflow housing 111. A plurality of connection blades 14 connect the pressurizing member 13 with the front housing 11. A base 131 and a sleeve 132 are arranged inside the pressurizing member 13. The base 131 is disposed between a front end and a rear end of the pressurizing member 13 and defines an avoiding space 1321 backward inside the pressurizing member 13. The base 131 defines a receiving portion 1322 towards the front inside the pressurizing member 13. The sleeve 132 protrudes from the base 131 towards a receiving cavity 162, and that is, the sleeve 132 protrudes backwardly from the base 131, and the sleeve 132 is hollow.

As shown in FIGS. 2-1 and 2-2, the air inlet 161 is located in a radially inward region of the second inner housing. The air outlet 163 is located in a region between the pressurizing member 13 and the radial direction of the first inner housing. The fan assembly 2 includes a hub 21 and a plurality of fan blades 22, and the plurality of fan blades 22 are spaced apart from each other and arranged on an outer surface of the hub 21. The hub 21 includes an airflow guiding surface 212 that is radially increased from the rear to the front. The pressurizing member 13 includes a pressurizing surface 133 that is radially increased from the rear to the front. The airflow guiding surface 212 and the pressurizing surface 133 are disposed in close proximity to each other having an interval therebetween, allowing the airflow to be blown smoothly towards the front. An air duct, that is extending radially outwardly, is formed from the air inlet 161 to the air outlet 163, such that the airflow is pressurized inside the housing 1, and a relatively large air outlet surface is formed.

As shown in FIGS. 2-1 to 2-4, the fan assembly 2 includes the hub 21 and the plurality of fan blades 22. The plurality of fan blades 22 are spaced apart from each other and arranged on an outer surface of the hub 21. A rotation shaft 23 is fixedly arranged at a center of an inside of the hub 21. The motor 3 includes a stator 31 and a rotor 32. The stator 31 and the rotor 32 are both arranged inside the hub 21. Further, the hub 21 includes an annular extension wall 211 that is arranged inside the hub 21 and extends for one loop of the hub 21. The stator 31 and the rotor 32 are arranged inside the extension wall 211. The stator 31 sleeves an outside of the sleeve 132. The stator 31 includes a coil 311. The rotor 32 is radially disposed between the stator 31 and the hub 21. The rotation shaft 23 is inserted into the sleeve 132, and the extension wall 211, the stator 31 and the rotor 32 extend forwardly into the avoiding space 1321.

As shown in FIGS. 2-1 and 2-2, the extension wall 211 extends forwardly beyond the airflow guiding surface 212. The airflow guiding surface 212 and the pressurizing surface 133 are disposed in close proximity to each other and are spaced apart from each other. Therefore, a gap between the airflow guiding surface 212 and the pressurizing surface 133 is misaligned with the front end of the extension wall 211, and dust may not enter the extension wall 211. The stator 31 and the rotor 32 do not extend forwardly beyond the extension wall 211. The extension wall 211, the stator 31 and the rotor 32 extend forwardly into the avoiding space 1321, such that the extension wall 211, the stator 31 and the rotor 32 are partially received the avoiding space 1321.

As shown in FIGS. 2-1 and 2-2, the drive circuit board 4 is not disposed between the base 131 and the stator 31, the battery 7 is electrically connected to the drive circuit board 4, and the drive circuit board 4 is electrically connected to leads of the coil 311, so as to drive the fan assembly 2 to rotate to drive the airflow from the air inlet 161, flowing through the receiving cavity 162, to be discharged from the air outlet 163. In the present embodiment, the drive circuit board 4 is received in the receiving portion 1322 formed by the base 131 towards the front. The front end of the pressurizing member 13 further includes a front cover 15, the front cover 15 covers the front end of the receiving portion 1322. The front cover 15 is recessed rearwardly to form a negative pressure region 151. By arranging the front cover 15, the receiving portion 1322 is covered to shield and protect the drive circuit board 4. On the other hand, the negative pressure region 151, which is formed by the front cover 15 being recessed rearwardly, compensates air to the air outlet 163 to increase the amount of airflow at the air outlet 163.

As shown in FIGS. 2-1 to 2-4, in this embodiment, the motor 3 is a three-phase motor, and the coil 311 includes twelve windings. The number of the windings is large, and therefore, a space inside the motor 3 is limited. Since the drive circuit board 4 is not disposed between the base 131 and the stator 31, electrical connection between the leads of the coil 311 and the drive circuit board 4 is simpler and more convenient, and in addition, the space between the base 131 and the stator 31 is further reduced, such that utilization of the space inside the portable fan is more reasonable, and the portable fan can be miniaturized.

As shown in FIG. 2-5, a schematic view of the portable fan is shown. In the present embodiment, the drive circuit board 4 is arranged inside the handheld portion 17 and is disposed between the switch 5 and the interface 6. The switch 5 is connected to the drive circuit board 4, or the interface 6 is connected to the drive circuit board 4. Other structures and performance of the present embodiment are substantially the same as those in the first embodiment, and will not be repeated herein.

As shown in FIGS. 2-6, a schematic view of the portable fan is shown. In the present embodiment, the drive circuit board 4 is arranged inside the handheld portion 17 and is disposed below the battery 7. Other structures and performance of the present embodiment are substantially the same as those in the first embodiment, and will not be repeated herein.

In the above embodiment, the drive circuit board is not disposed between the base and the stator, such that the electrical connection between the lead wire of coils and the drive circuit board is simpler and more convenient. Furthermore, the spacing between the base and the stator can be further reduced, enabling an internal space of the portable fan can be utilized more reasonably, allowing the portable fan to be miniaturized.

Embodiment 3-1, referring to FIGS. 3-1 to 3-5:

A portable fan includes an airflow portion 100. As shown in FIGS. 3-1 to 3-3, the airflow portion 100 includes a housing 1 having a receiving chamber, an airflow assembly 2 arranged in the receiving chamber of the housing 1, a display screen 3 disposed at a front end of the housing 1, air outlets disposed around a periphery of the display screen 3, and an air inlet disposed at a rear end of the housing 1. The display screen 3 is configured to display an operating state. It should be noted that in the present embodiment, the front end refers to an end facing towards a user when the portable fan is being in use; and the rear end refers to an end facing away from the user when the portable fan is being in use. The inside refers to a side facing towards a central axis of the housing 1, and the outside refers to a side facing away from the central axis of the housing 1. A top refers to a side of the handheld portion 200 facing towards the airflow portion 100. While in use, the display screen 3 may display a remaining battery power, a current airflow speed, and a power level during charging.

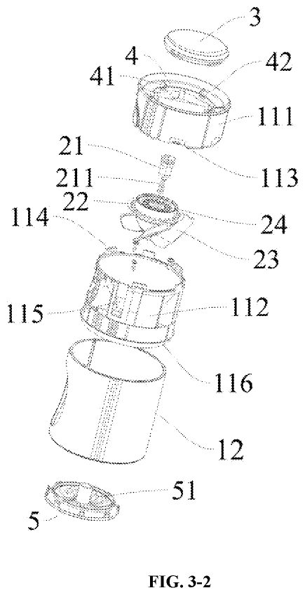

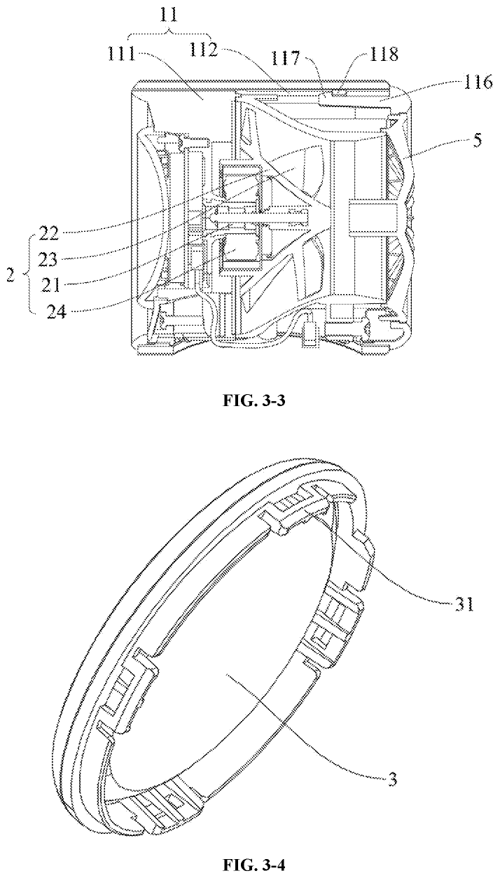

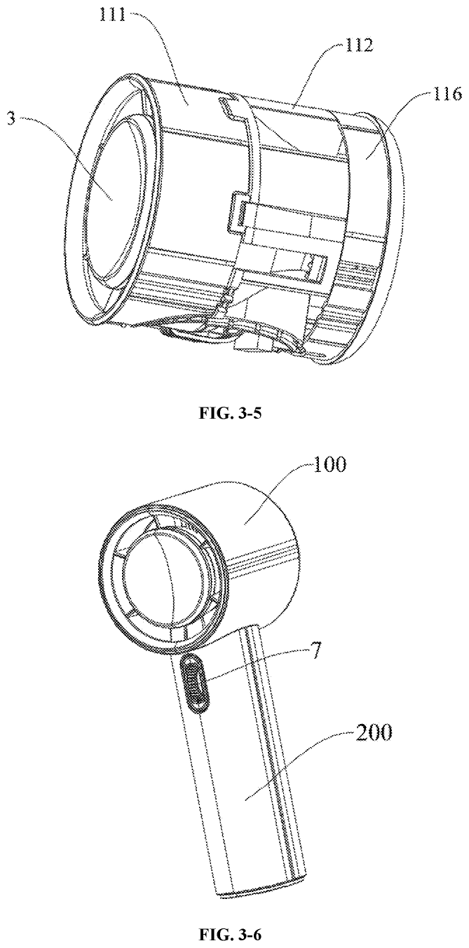

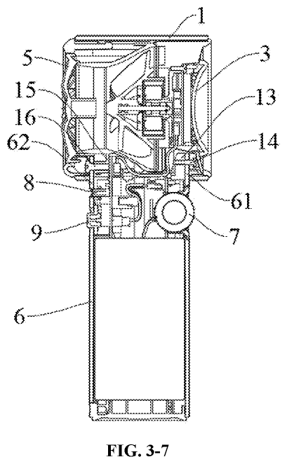

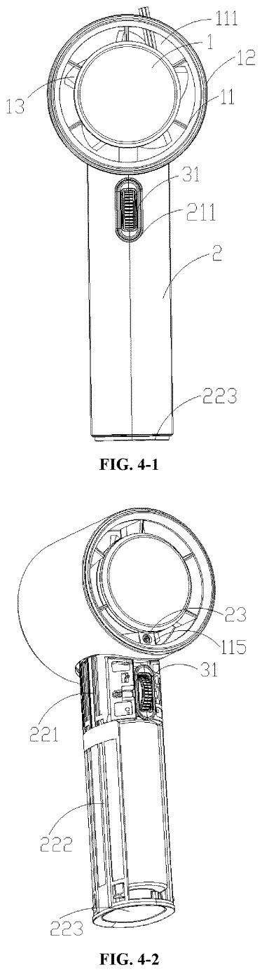

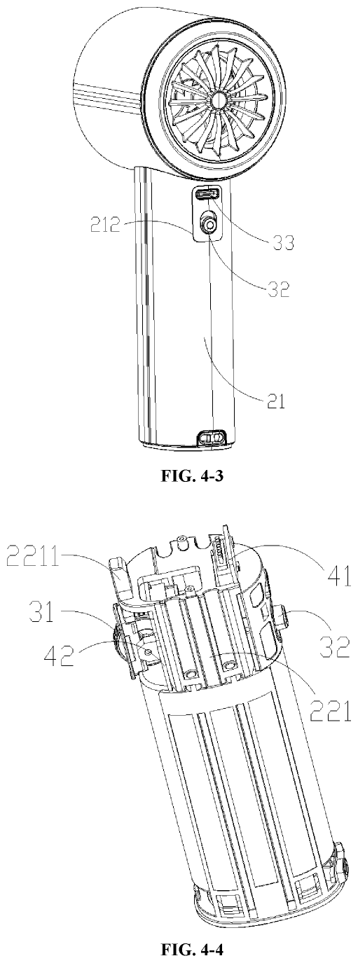

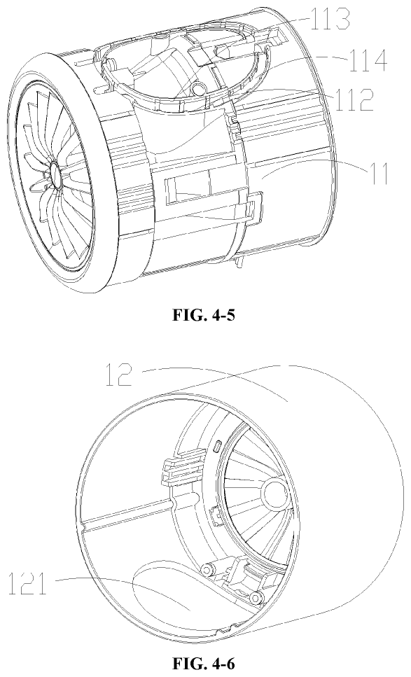

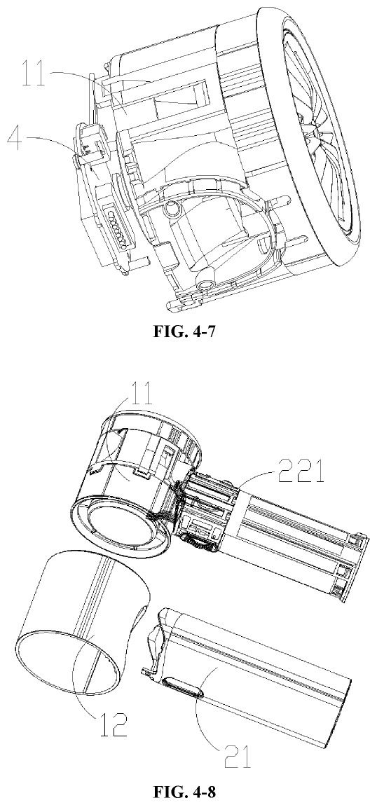

As shown in FIG. 3-4, the display screen 3 is disposed corresponding to a region of the central axis of the receiving chamber. The display screen 3 has a surface that is at least partially curved. For example, the surface of the display screen 3 may be at least partially concave from the front end to the rear end of the housing 1, or at least partially convex outwardly from the front end of the housing 1. In some embodiments, the display screen 3 is concave, along the axial direction, from the central axis towards the rear end of the housing 1, so that a front surface of the display screen 3 is concave. The front surface of the display screen 3 is concave towards the rear end of the housing 1, such that the airflow from the air outlet is gathered in a region corresponding to the display screen 3, the airflow output from the portable fan is more concentrated, improving the air flowing effect, improving the usage experience, and saving energy, increasing the battery life of the portable fan. As shown in FIG. 3-3, in some embodiments, a plane enclosed by an edge of the display screen 3 is recessed from a plane formed by an edge of the front end of the housing 1. That is, the plane formed by the display screen 3 is disposed closer to the air inlet than the plane formed by the edge of the front end of the housing 1 is. In this way, the display screen 3 is disposed in the receiving chamber of the housing 1, and the display screen 3 can be protected from wear or damage.

As shown in FIGS. 3-2 to 3-5, the housing 1 includes an inner shell 11 and an outer shell 12 sleeving an outside of the inner shell 11. The inner shell 11 includes a first inner shell 111 and a second inner shell 112 that are arranged from front to rear. A connecting seat 4 for mounting the display screen 3 is arranged in the receiving chamber at a position corresponding to a rear of the display screen 3. A plurality of reinforcing plates 41 are disposed between a periphery of the connecting seat 4 and an inner wall of the first inner shell 111. The plurality of reinforcing plates 41 are evenly distributed around the periphery of the connecting seat 4 and divide the air outlet into a plurality of sub-air-outlets that are evenly distributed around the periphery of the display screen 3. In some embodiments, a cross section of each sub-air-outlet, taken along a radial direction of the housing 12, is trapezoidal arc-shaped. The plurality of reinforcing plates 41 provide support for the first inner shell 111 and connect the connecting seat 4 with the inner wall of the first inner shell 111, enhancing strength of the first inner shell 111. Each of an outer wall of the inner shell 11 and an inner wall of the outer shell 12 are arranged with a matching connecting structure. In some embodiments, the matching connecting structure includes a connecting groove extending along an axial direction on the outer wall of the inner shell 11 and a connecting protrusion arranged on the inner wall of the outer shell 12 and mated with the connecting groove. The connecting groove and the connecting protrusion are mated with each other to guide connection between the inner shell 11 and the outer shell 12, preventing relative rotation between the inner shell 11 and the outer shell 12, enhancing connection stability between the inner shell 11 and the outer shell 12.

The display screen 3 and the connecting seat 4 are connected to each other via a first snap-fit assembly. The first snap-fit assembly includes: a first snap 31 arranged on a rear surface of the display screen 3 along a circumferential direction of the display screen 3; and a first snap block 42 arranged at the front end of the connecting seat and mated with the first snap 31.

Further, the first snap extends from the rear surface of the display screen towards the air inlet, and an outer side of a rear end of the first snap 31 is arranged with a slope. The slope reduces resistance when the first snap 31 and the first snap block 42 are mated and connected to each other, reducing assembling difficulty, improving an assembling efficiency, providing a buffering effect, avoiding damage to corners when the first snap 31 and the first snap block 42 are connected, and facilitating demolding during production. In some embodiments, the first snap-fit assembly includes: the first snap block 42 arranged at the rear of the display screen 3; and the first snap 31 defined in the front end of the connecting seat and mated with the first snap block 42.

As shown in FIG. 3-5, a second snap-fit assembly is arranged at a connecting region between the first inner shell 111 and the second inner shell 112. The second snap-fit assembly includes a second snap block 113 arranged at the rear end of the first inner shell 111 and a second snap 114 arranged at the front end of the second inner shell 112 and mated with the second snap block 113. Alternatively, a position where the second snap block 113 is arranged and a position where the second snap 114 is arranged can be exchanged. For example, in some embodiments, the second snap 114 is arranged at the rear end of the first inner shell 111, and the second snap block 113 is arranged at the front end of the second inner shell 112.

As shown in FIGS. 3-2 and 3-3, the airflow assembly 2 includes a drive motor 21 arranged along the central axis of the receiving chamber, a fan rotor 22 arranged on a rotation shaft 211 of the drive motor 21, and fan blades 23 arranged on an outer wall of the fan rotor 22. The fan rotor 22 is hollow and truncated conical, an end of the fan rotor 22 having a larger inner diameter faces towards the air outlet. The fan blades 23 are spiral streamline-shaped, reducing resistance of the airflow flowing from the air inlet to the air outlet, further ensuring an airflow outputting effect of the portable fan. The fan rotor 22 at least partially extends to reach the drive motor 21. A rotating bearing 24 is arranged to sleeve a region of the drive motor 21 corresponding to the fan rotor 22 and is connected to an inner wall of the fan rotor 22. In some embodiments, the fan rotor 22 and the rotation shaft 211 of the drive motor 21 are connected to each other via a connecting member. The fan rotor 22 and the blades 23 are integrally formed as a one-piece structure. The structural configuration of the drive motor 21 and the fan rotor 22 reduces a space occupied by the airflow portion 100. The rotating bearing 24 ensures rotational stability of the fan rotor 22, thereby ensuring overall operational stability of the portable fan.

A cover 115 is arrange at a region of the second inner shell 112 corresponding to the fan blades 23 and sleeves the fan blades 23. A rear end of the cover 115 is fluidly communicated with the air inlet. An inner diameter of the cover 115 gradually decreases from front to rear. The air inlet is covered by a rear cover 5, and the rear cover 5 defines an opening 51 for allowing air to enter the receiving chamber. Since the cover 115 is fluidly communicated with the air inlet, the air, after entering the receiving chamber, can be guided by the cover 115 to directly flow towards the blades 23 and the fan rotor 22. The fan rotor 22 drives the fan blades 23 to rotate, forming a vortex air channel. The air channel formed by the cover 115, the fan blades 23, and the fan rotor 22 enhances an air guiding effect and improves the air outputting effect. In some embodiments, the rear cover 5 is arranged with a plurality of connecting strips that are scattering outwardly from a central axis to an edge of the rear cover. Gaps between the plurality of connecting strips form the opening 51. Further, in some embodiments, the plurality of connecting strips are convex rearwardly, reducing resistance to the airflow and ensuring an air intaking effect. In some embodiments, the rear cover 5 defines a plurality of holes, which may be circular, square, or in other shapes, to form the opening 51.

Further, as shown in FIGS. 3-2, 3-3, and 3-5, the rear cover 5 and the second inner shell 112 are connected to each other via a fixing ring 116. The rear cover 5 is snapped to a rear end of the fixing ring 116, and a front end of the fixing ring 116 is connected to a rear end of the second inner shell 112 via a third snap-fit assembly. The third snap-fit assembly includes a third snap 117 arranged at the front end of the fixing ring 116 and a third snap block 118 arranged at the rear end of the second inner shell 112 and mated with the third snap 117. As shown in FIG. 3-3, an outer wall of the third snap 117 is arranged with a cut surface to facilitate snapping between the third snap 117 and the third snap block 118, improving a mounting efficiency. In some embodiments, the third snap-fit assembly includes a third snap block 118 arranged at the front end of the fixing ring 116 and the third snap 117 arranged at the rear end of the second inner shell 112 and mated with the third snap block 118.

The portable fan further includes a power supply, which is electrically connected to the display screen 3 and the drive motor 21.

Embodiment 3-2, referring to FIGS. 3-6 and 3-7:

In the present embodiment, a portable fan includes the airflow portion 100 described in the Embodiment 1. As shown in FIGS. 3-6 and 3-7, the portable fan further includes a handheld portion 200 connected to the airflow portion 100. The handheld portion 200 includes a handle 6, an air speed adjustment knob 7, a charging port 8, and a power button 9, where the air speed adjustment knob 7, the charging port 8, and the power button 9 are arranged on the handle 6.

The power supply is arranged inside the handle 6, the handle 6 defines a mounting slot in which the power supply is mounted. The air speed adjustment knob 7, the charging port 8, and the power button 9 are electrically connected to the power supply. The charging port 8 is used to charge the power supply, and the power button 9 controls the drive motor 21, the display screen 3, and the air speed adjustment knob 7 to be connected with the power supply. The air speed adjustment knob 7 is electrically connected to the drive motor 21 to control an output power of the drive motor 21. While in use, by rotating the air speed adjustment knob 7, the output power of the drive motor 21 is adjusted, and the fan rotor 22 is driven by the drive motor 21 to drive the fan blades 23 to rotate at various speeds, such that an air volume of the airflow from the air inlet to the air outlet can be adjusted, such that the air speed is adjusted. In this way, customized air speed control under various application scenarios can be achieved, improving the usage experience. In some embodiments, as shown in FIG. 3-7, the air speed adjustment knob 7 is arranged on a side of the handle 6 facing the user, such that operation can be performed easily. The charging port and the power button are arranged on a side of the handle 6 away from the user. In some embodiments, a dust cover may be arranged to the charging port to prevent dust and water from entering the charging port.

As shown in FIG. 3-7, a top of the handle 6 extends into the housing 1 of the airflow portion 100. Specifically, the top of the handle 6 includes a first connector 61 that extends into the housing 1 corresponding to the air outlet. At the air outlet, a second connector 13 corresponding to the first connector 61 is arranged. The first connector 61 and the second connector 13 are connected to each other via a first fastener 14. In some embodiments, to further enhance connection stability between the handheld portion 200 and the airflow portion 100, the handle 6 further includes a first connection plate 62 that extends into the housing 1 corresponding to the air inlet. At the air inlet, a second connection plate 15 corresponding to the first connection plate 62 is arranged. The first connection plate 62 and the second connection plate 15 are connected to each other via a second fastener 16. The first connection plate 62 and the first connector 61 are disposed opposite to each other.

While in use, the power button 9 is turned on, the display screen 3 is lit on to display the operating state, and the air speed adjustment knob 7 is rotated to adjust the air speed.

It is understood that in some embodiments, the portable fan may include only the airflow portion, which may be connected to some portable components. For example, when the portable fan is a neck-worn fan, the portable fan includes a curved wearable portion connected to the airflow portion.

Embodiment 4, referring to FIGS. 4-1 to 4-8:

The present disclosure provides a handheld fan. An airflow channel 111 is formed in an inner shell 11 of an airflow portion 1. An air inlet and an air outlet are respectively communicated to two sides of the airflow channel 111. The fan assembly 13 is received in the airflow channel 111. The outer shell 12 covers an outside of the inner shell 11. A handheld shell 21 of a handheld portion 2 covers an outside of a mounting mechanism. The handheld shell 21 extends into a mounting port 121 of the outer shell 12. A fixing member 23 sequentially penetrates the outer shell 12 of the airflow portion 1 and the handheld shell 21 and is further connected to the mounting mechanism. In this way, the handheld shell and mounting mechanism of the handheld portion 2 are connected, through the fixing member 23, to the outer shell 12 of the airflow portion 1. The airflow channel 111 formed in the inner shell 11 of the airflow portion 1 allows air to flow through, a structure of the handheld fan is compact, and stability and reliability of the handheld fan during operation may be improved. Therefore, compactness and reliability of the handheld fan are achieved.

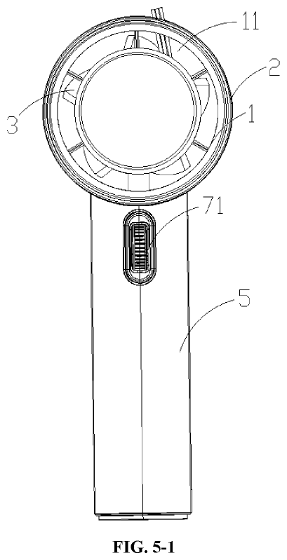

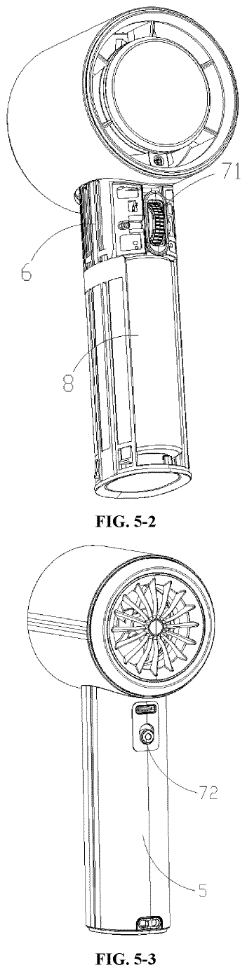

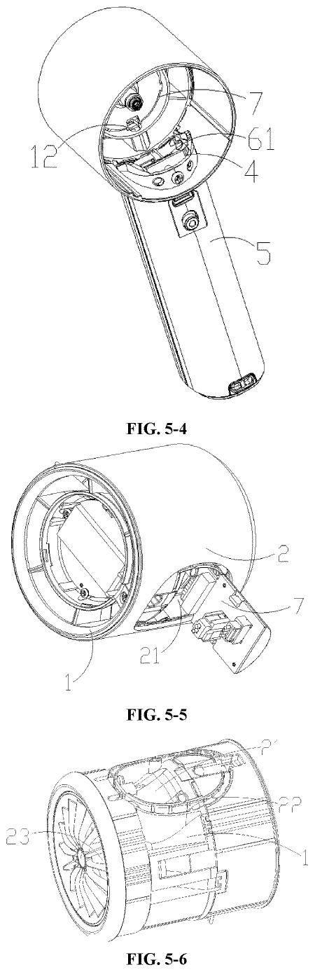

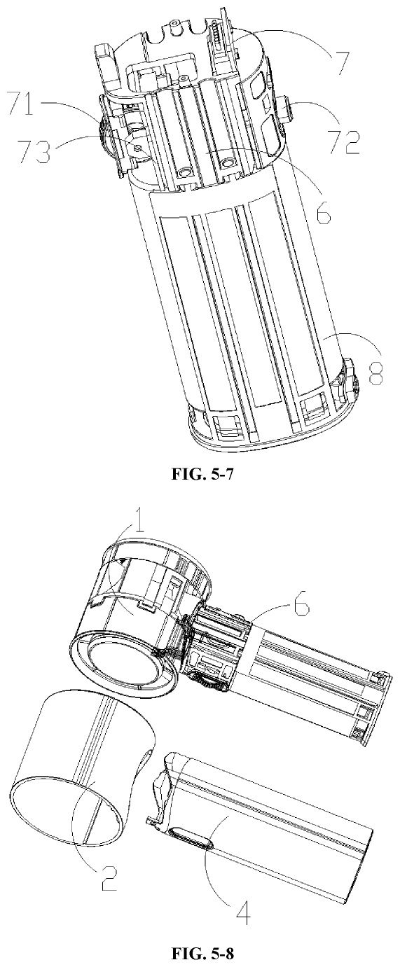

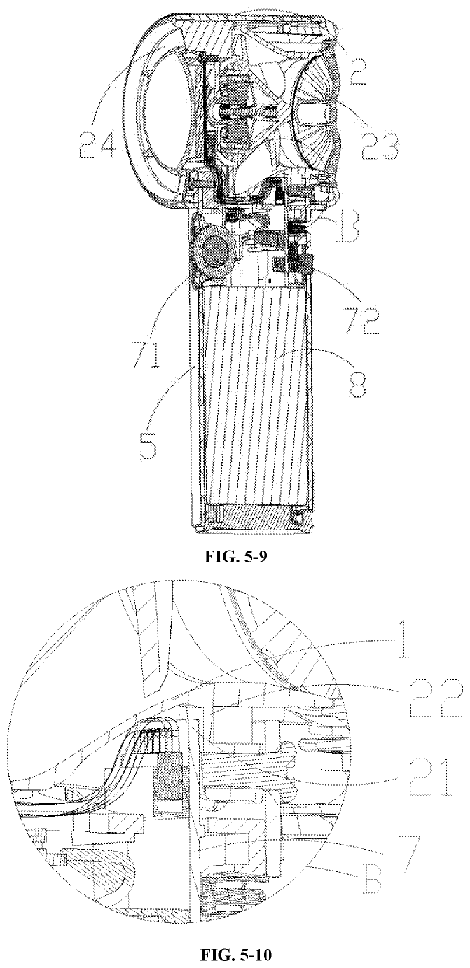

As shown in FIGS. 4-1 to 4-8, FIG. 4-1 is a structural schematic view of a handheld according to an embodiment of the present disclosure; FIG. 4-2 is a structural schematic view of a mounting bracket 211 in the handheld fan according to an embodiment of the present disclosure; FIG. 4-3 is a structural schematic view of a handheld shell 21 of the handheld fan according to an embodiment of the present disclosure; FIG. 4-4 is a structural schematic view of a control mechanism in the handheld fan according to an embodiment of the present disclosure; FIG. 4-5 is a structural schematic view of a mounting groove 114 in the handheld fan according to an embodiment of the present disclosure; FIG. 4-6 is a structural schematic view of an outer shell 12 of the handheld fan according to an embodiment of the present disclosure; FIG. 4-7 is a structural schematic view of a first circuit board 4 in the handheld fan according to an embodiment of the present disclosure; FIG. 4-8 is a structural schematic view of an inner shell 11 in the handheld fan according to an embodiment of the present disclosure. The present embodiment provides a handheld fan including an airflow portion 1 and a handheld portion 2. The airflow portion 1 and the handheld portion 2 will be described in detail in the following.

For the airflow portion 1 and the handheld portion 2:

The airflow portion 1 includes an inner shell 11, an outer shell 12 and a fan assembly 13. In the inner shell 11, an airflow channel 111, an air inlet communicated to a side of the airflow channel 111, and an air outlet communicated to the other side of the airflow channel 111 are formed. The fan assembly 13 is received in the airflow channel 111. The outer shell 12 covers an outside of the inner shell 11. The outer shell 12 has a mounting port 121. The inner shell 11 may be arranged with a limit plate 112 and a baffle plate 113, the limit plate 112 and the baffle plate 113 enclose to define a mounting groove 114. An end of the handheld shell 21 is inserted into the mounting groove 114. The handheld portion 2 includes a handheld shell 21, a mounting mechanism and a fixing member 23. The handheld shell 21 covers an outside of the mounting mechanism, and the handheld shell 21 is inserted into the mounting port 121. The fixing member 23 sequentially penetrates the outer shell 12 and the handheld shell 21 to be further connected to the mounting mechanism. The mounting mechanism includes a mounting bracket 221, clamping plates 222 and a sealing cover 223. The mounting bracket 221 is connected to the fixing member 23. The clamping plates 222 are connected to the mounting bracket 221. The sealing cover 223 is detachably connected to the clamping plates 222. The sealing cover 223, the clamping plates 222 and the mounting bracket 221 enclose to form a space for receiving a battery. A first connecting member 115 is arranged on the inner shell 11, a second connecting member 2211 is arranged in the mounting mechanism. The fixing member 23 penetrates the first connecting member 115 and the second connecting member 2211.

Specifically, the airflow channel 111 is formed inside the inner shell 11 for allowing the air to flow through. The air enters the airflow channel 111 from the air inlet, enters the airflow channel 111, and then flows out of the fan from the air outlet. The outer shell 12 overs the outside of the inner shell 11. The mounting port 121 defined in the outer shell 12 has a space for receiving the end of the handheld shell 21 of the handheld portion 2 and the mounting bracket 221 in the mounting mechanism. The limit plate 112 and the baffle plate 113 are disposed in the inner shell 11 at a position directly opposite to the mounting port 121. The mounting groove 114 is formed between the limit plate 112 and the baffle plate 113, and an end of the handheld shell 21 may be embedded in the mounting groove 114. The end of the handheld shell 21 can be limited by the mounting groove 114.

It should be noted that the end of the handheld shell 21 of the handheld portion 2 is inserted, after being mounted into the mounting port 121, into the mounting groove 114. The first connecting member 115 may be arranged on the mounting bracket 221 in the mounting mechanism. The second connecting member 2211 may be disposed on the inner shell 11 at a position corresponding to the mounting bracket 221. The fixing member 23, after penetrating the outer shell 12, the handheld shell 21 and the second connecting member 2211 arranged on the second connecting member 2211, may be further connected to the first connecting member 115 arranged on the mounting bracket 221, and the fixing member 23 may include a bolt. Two clamping plates 222 may be disposed respectively at two sides inside the handheld shell 21. The clamping plates 222 are connected to the mounting bracket 221, and the sealing cover 223 may be detachably connected to the clamping plates 222. For example, a snap head may be arranged on the sealing cover 223, and a snap groove is defined in each clamping plate 222, such that detachable connection between the sealing cover 223 and the clamping plates 222 is achieved. The battery may be received in a space formed by the sealing cover 223, the clamping plates 222, and the mounting bracket 221.

The handheld fan of the present embodiment further includes a control mechanism, a first circuit board 4, a second circuit board 41 and a third circuit board 42. The control mechanism includes a gear knob assembly 31, a protective switch button assembly 32 and a charging port 33. The gear knob assembly 31 is arranged in the mounting mechanism. The handheld shell 21 defines: a first slot 211 directly opposite to the gear knob assembly 31; and a second slot 212 directly opposite to the protection switch button assembly 32. The first circuit board 4 is arranged in the mounting mechanism and is connected to the gear knob assembly 31. The protective switch button assembly 32 is arranged in the mounting bracket 221. The protective switch button assembly 32 and the gear knob assembly 31 are disposed opposite to each other. The second circuit board 41 is arranged in the mounting bracket 221, the second circuit board 41 is connected to the protective switch button assembly 32 and the first circuit board 4. The charging port 33 is arranged in the mounting bracket 221 and is connected to the second circuit board 41. The charging port 33 is directly opposite to the second slot 212. The third circuit board 42 is arranged in the inner shell 11. The third circuit board 42 is connected to the second circuit board 41.

Specifically, the first circuit board 4 and the second circuit board 41 are distributed in opposition to each other on the mounting bracket 221 of the mounting mechanism. The first circuit board 4 is connected to the gear knob assembly 31 in the control mechanism. The second circuit board 41 is connected to the protective switch button assembly 32, the charging port 33, the battery, and the first circuit board 4. The third circuit board 42 is connected to the second circuit board 41, and the third circuit board 42 may further be connected to a motor in the fan assembly 13, and the motor in the fan assembly 13 may drive the fan blades to rotate. The protective switch button assembly 32 may control a circuit powered by the battery to be on or off. For example, the protective switch button assembly 32 may be a slide switch. When a button in the protective switch button assembly 32 is slid to one end, the circuit is conducted, and at this moment, the motor in the fan assembly 13 is operating to drive the fan blades to rotate. When the button in the protective switch button assembly 32 is slid to the other end, the circuit is disconnected, the motor in the fan assembly 13 does not operate, and the fan blades do not rotate. The user may be prevented from accidentally turning on the fan after mistakenly touching the gear knob assembly 31. The gear knob assembly 31 may adjust a rotation speed of the fan blades connected to the third circuit board 42 to control the air speed. When rotating a knob in the gear knob assembly 31, a gear of the air speed may be adjusted. When pressing the knob in the gear knob assembly 31, a battery power level may be checked. The charging port 33 may refer to a USB port, and the charging port 33 may charge the battery when being connected to an external power source.

For the handheld fan of the present embodiment, the airflow channel 111 is formed in an inner shell 11 of an airflow portion 1. The air inlet and the air outlet are respectively communicated to two sides of the airflow channel 111. The fan assembly 13 is received in the airflow channel 111. The outer shell 12 covers the outside of the inner shell 11. The handheld shell 21 of the handheld portion 2 covers the outside of the mounting mechanism. The handheld shell 21 extends into the mounting port 121 of the outer shell 12. The fixing member 23 sequentially penetrates the outer shell 12 of the airflow portion 1 and the handheld shell 21 and is further connected to the mounting mechanism. In this way, the handheld shell and mounting mechanism of the handheld portion 2 are connected, through the fixing member 23, to the outer shell 12 of the airflow portion 1. The airflow channel 111 formed in the inner shell 11 of the airflow portion 1 allows air to flow through, a structure of the handheld fan is compact, and stability and reliability of the handheld fan during operation may be improved. Therefore, compactness and reliability of the handheld fan are achieved.

Embodiment 5-1, referring to FIGS. 5-1 to 5-11:

The present disclosure provides a handheld fan. An air duct 11 is defined in an inner housing 1. Two sides of the air duct 11 are respectively connected to an air inlet 23 and an air outlet 24. At least a portion of a fan assembly 3 is received in the air duct 11. An outer housing 2 covers an outside of the inner housing 1. A side of a wire opening 12 of the inner housing 1 directly faces an electrical connection portion of the fan assembly 3. The other side of the wire opening 12 directly faces an electrical connection portion of a handheld portion 5 of the handheld fan. In this way, the wire opening 12 of the inner housing 1 allows a wire connected to the electrical connection portion of the fan assembly 3 to pass through. After the wire connected to the electrical connection portion of the fan assembly 3 passes through the wire opening 12 from a position directly facing the electrical connection portion of the handheld portion of the handheld fan 5, the wire is then connected to the electrical connection portion of the handheld portion of the fan 5. In this way, a length of the wire is reduced, durability of the wire in improved, an aesthetic appearance of wires is improved. Wires can be arranged stably, an appearance of the wire arrangement is improved, and the durability is improved.

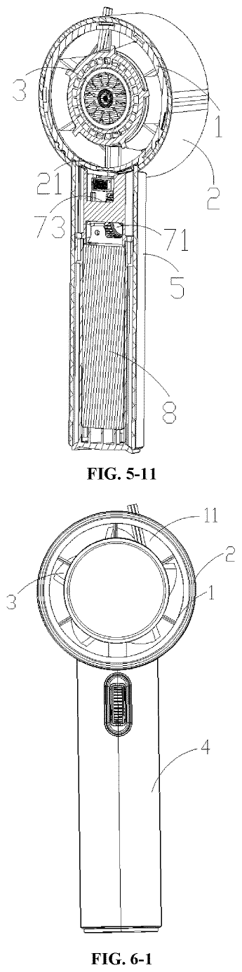

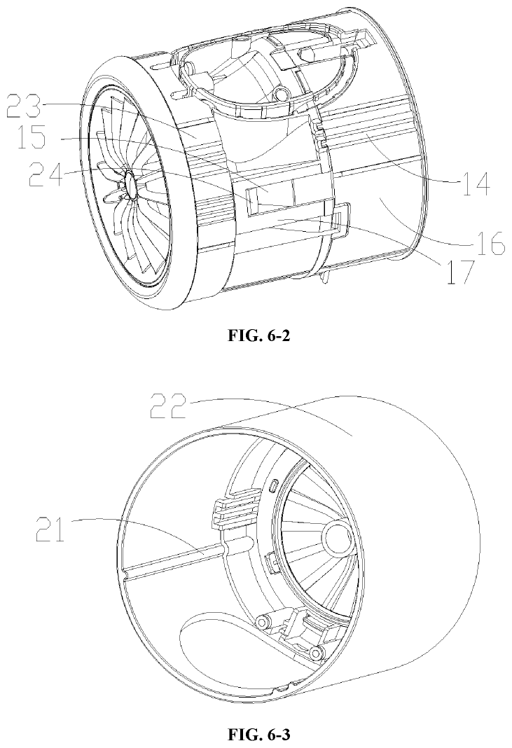

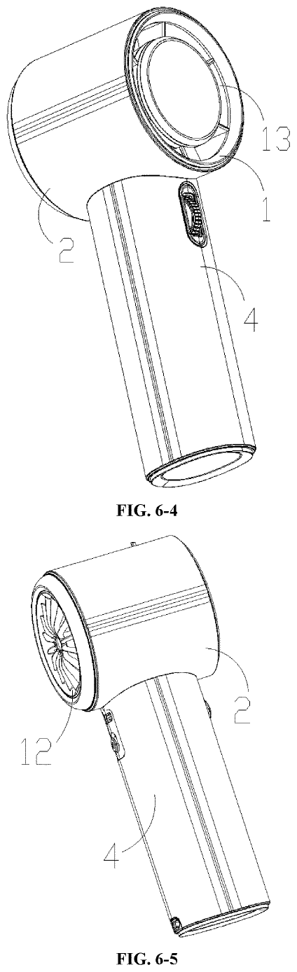

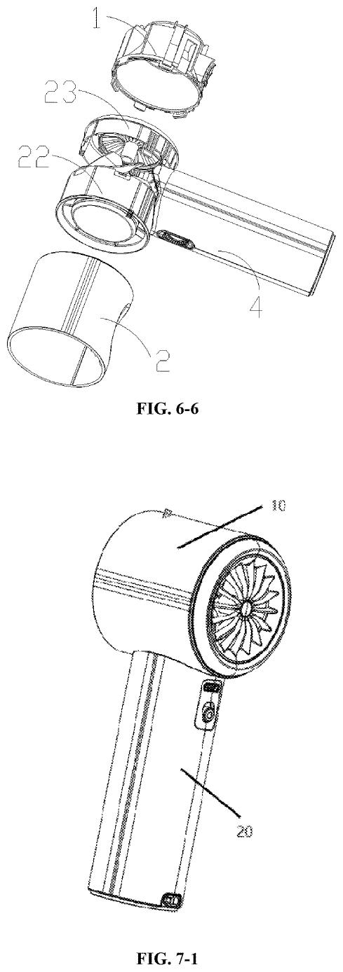

As shown in FIGS. 5-1 to 5-11, FIG. 5-1 is a structural schematic view of an airflow component of a handheld fan according to an embodiment of the present disclosure; FIG. 5-2 is a structural schematic view of a mounting bracket 6 in the airflow component of the handheld fan according to an embodiment of the present disclosure; FIG. 5-3 is a structural schematic view of a handheld portion 5 in the airflow component of the handheld fan according to an embodiment of the present disclosure; FIG. 5-4 is a structural schematic view of a wire opening 12 in the airflow component of the handheld fan according to an embodiment of the present disclosure; FIG. 5-5 is a structural schematic view of a wire receiving groove 21 in the airflow component of the handheld fan according to an embodiment of the present disclosure; FIG. 5-6 is a structural schematic view of the wire receiving groove 21 in the airflow component of the handheld fan according to an embodiment of the present disclosure; FIG. 5-7 is a structural schematic view of a gear knob assembly 71 and a protective switch button assembly 72 in the airflow component of the handheld fan according to an embodiment of the present disclosure; FIG. 5-8 is a structural schematic view of an inner shell 1 and an outer shell 2 of the airflow component of the handheld fan according to an embodiment of the present disclosure; FIG. 5-9 is a structural schematic view of an air inlet 23 and an air outlet 24 of the airflow component of the handheld fan according to an embodiment of the present disclosure; FIG. 5-10 is an enlarged view of a portion B in FIG. 5-9; FIG. 5-11 is a structural schematic view of a fan assembly 3 of the airflow component of the handheld fan according to an embodiment of the present disclosure. The handheld fan of the present embodiment includes an inner housing 1, an outer shell 2, and a fan assembly 3. The inner shell 1, the outer shell 2, and the fan assembly 3 will be described in detail.

For the inner shell 1, the fan assembly 3, and the outer shell 2:

The inner shell 1 defines an air duct 11, an air inlet 23 communicated to a side of the air duct 11, and an air outlet 24 communicated to the other side of the air duct 11. At least part of the fan assembly 3 is received in the air duct 11. The inner shell 1 defines a wire opening 12. A side of the wire opening 12 directly faces an electrical connection portion of the fan assembly 3, the other side of the wire opening 12 directly faces an electrical connection portion of a handheld portion 5 of the handheld fan. The electrical connection portion of the fan assembly 3 is electrically connected to the electrical connection portion of the handheld portion 5 by a wire passing through the wire opening 12. The handheld portion 5 has a mounting opening 4 and is connected to the outer shell 2. The mounting opening 4 directly faces the other side of the wire opening 12. The handheld fan further includes a mounting bracket 6, a second circuit board 73 and a gear knob assembly 71, all of which are arranged in the handheld portion 5. At least a portion of the mounting bracket 6 is received in the mounting opening 4. The mounting bracket 6 is connected to the inner shell 1, and the mounting bracket 6 defines a receiving space 61 allowing the wire to pass through. The electrical connection portion of the handheld portion 5 includes a first circuit board 7, the first circuit board 7 is arranged in the mounting bracket 6. The first circuit board 7 is plugged to the electrical connection portion of the fan assembly 3 by the wire. The second circuit board 73 is arranged in the mounting bracket 6, the second circuit board 73 is plugged to the first circuit board 7 by the wire. The gear knob assembly 71 is arranged in the mounting bracket 6. The gear knob assembly 71 is connected to the second circuit board 73. The second circuit board 73 is disposed opposite to the first circuit board 7. The outer shell 2 is arranged to cover an outside of the inner shell 1. A shielding plate 22 is arranged on the inner shell 1. The shielding plate 22 and the inner shell 1 enclose to form a wire receiving groove 21. At least a portion of the first circuit board 7 is received in the wire receiving groove 21.

Specifically, the air duct 11 defined the inner shell 1 is defined to allow air to flow through. The air enters the air duct 11 from the air inlet 23, and the air entering the air duct 11 is then discharged from the air outlet 24. The outer shell 2 covers the outside of the inner shell 1. The inner shell 1 defines a wire opening 12 allowing the wire to pass through. Two sides of the wire opening 12 respectively face the electrical connection portion of the fan assembly 3 and the electrical connection portion of the handheld portion 5 of the handheld fan. The electrical connection portion of the fan assembly 3 may refer to a circuit board connected to the fan motor. The wire connected to the circuit board passes through the wire opening 12 and then is connected to the first circuit board 7 of the electrical connection portion of the handheld portion 5. The mounting opening 4 of the handheld portion 5 faces the wire opening 12, the receiving space 61 of the mounting bracket 6 is communicated with the mounting opening 4 of the handheld portion 5. The first circuit board 7 and the second circuit board 73 are disposed opposite to each other and arranged on the mounting bracket 6. The wire passing through the alignment opening 12 passes through the mounting opening 4 of the handheld portion 5 and is then plugged to the first circuit board 7 arranged on the mounting bracket 6. For example, an end of the wire passing through the wire opening 12 is plugged, via a plugger, to the first circuit board 7, facilitating connection or disconnection between the wire and the first circuit board 7. The second circuit board 73 is plugged to the first circuit board 7 by the wire. For example, the second circuit board 73 is connected, via the wire, to the plugger connected to the first circuit board 7, achieving plugging between the second circuit board 73 and the first circuit board 7 and facilitating connection or disconnection between the second circuit board 73 and the first circuit board 7. The gear knob assembly 71 connected to the second circuit board 73 is configured to adjust a rotation speed of fan blades in the fan assembly 3 to control of an airflow speed. For example, when a knob in the gear knob assembly 71 is rotated, a gear of the fan is adjusted. When the knob in the gear knob assembly 71 is pressed, a power level of the battery 8 can be checked. The shielding plate 22 is disposed in the inner shell 1 near the handheld portion 5, a diameter of the inner shell 1 is gradually increased in a direction extending from the air inlet 23 to the air outlet 24. In this way, an end of the inner shell 1 near the air inlet 23 is inwardly recessed to form a recessed space. The shielding plate 22 is arranged at the inwardly recessed space. The inner shell 1 and the shielding plate 22 cooperatively form a wire groove 21. A portion of the first circuit board 7 extends to an inside of the wire receiving groove 21, and the inside of the wire receiving groove 21 provides a space for receiving the wire connected to the first circuit board 7. Alternatively, the entirety of the first circuit board 7 is arranged at an outside of the wire receiving groove 21, and a portion of the wire connected to the first circuit board 7 is received in the wire receiving groove 21. Another portion of the wire extends to the outside of the wire receiving groove 21 and is then connected to the first circuit board 7. In this way, space utilization is improved.

The handheld fan of the present embodiment further includes a protective switch button assembly 72 and a battery 8. The protective switch button assembly 72 is arranged in the mounting bracket 6. The protective switch button assembly 72 is electrically connected to the first circuit board 7. The battery 8 is arranged in the handheld portion 5. The battery 8 is plugged into the first circuit board 7 via a wire.

Specifically, the battery 8 can be mounted in the handheld portion 5. The battery 8 and the first circuit board 7 are plugged into each other via the wire. The battery 8 can supply power to the fan assembly 3. The protective switch button assembly 72 electrically connected to the first circuit board 7 can control a circuit for power supply through the battery 8 to be conductive or disconnected. For example, the protective switch button assembly 72 is a slide switch. When a button of the protective switch button assembly 72 is slid to an end, the circuit is conducted. In this case, the motor in the fan assembly 3 operates to drive the fan blades to rotate. When the button of the protective switch button assembly 72 is slid to the other end, the circuit is disconnected, and in this case, the motor in the fan assembly 3 does not operate, and the fan blades do not rotate. In this way, the user is prevented from accidentally touching the gear knob assembly 71 to accidentally turn on the fan.

The present disclosure provides the handheld fan. The air duct 11 is defined in the inner shell 1. The two sides of the air duct 11 is communicated to the air inlet 23 and the air outlet 24. At least part of the fan assembly 3 is received in the air duct 11. The outer shell 2 covers the outside of the inner shell 1. A side of a wire opening 12 of the inner housing 1 directly faces an electrical connection portion of the fan assembly 3. The other side of the wire opening 12 directly faces an electrical connection portion of the handheld portion 5 of the handheld fan. In this way, the wire opening 12 of the inner shell 1 allows the wire connected to the electrical connection portion of the fan assembly 3 to pass through. After the wire connected to the electrical connection portion of the fan assembly 3 passes through the wire opening 12 from a position directly facing the electrical connection portion of the handheld portion of the handheld fan 5, the wire is then connected to the electrical connection portion of the handheld portion of the fan 5. In this way, a length of the wire is reduced, durability of the wire in improved, an aesthetic appearance of wires is improved. Wires can be arranged stably, an appearance of the wire arrangement is improved, and the durability is improved.

In order to provide a detailed description of the handheld fan of the present disclosure, the above embodiment 5-1 provides a detailed description of the handheld fan, and based on the same concept, the present disclosure further provides a handheld fan, as detailed in embodiment 5-2.

Embodiment 5-2, referring to FIGS. 5-1 to 5-11:

The embodiment 5-2 provides a handheld fan, including the airflow component of the handheld fan.

The present disclosure provides the handheld fan. The air duct 11 is defined in the inner shell 1. The two sides of the air duct 11 is communicated to the air inlet 23 and the air outlet 24. At least part of the fan assembly 3 is received in the air duct 11. The outer shell 2 covers the outside of the inner shell 1. A side of the wire opening 12 of the inner housing 1 directly faces the electrical connection portion of the fan assembly 3. The other side of the wire opening 12 directly faces the electrical connection portion of the handheld portion 5 of the handheld fan. The electrical connection portion of the fan assembly 3 is electrically connected to the electrical connection portion of the handheld portion 5 via the wire passing through the wire opening 12. In this way, the wire opening 12 of the inner shell 1 allows the wire connected to the electrical connection portion of the fan assembly 3 to pass through. After the wire connected to the electrical connection portion of the fan assembly 3 passes through the wire opening 12 from a position directly facing the electrical connection portion of the handheld portion of the handheld fan 5, the wire is then connected to the electrical connection portion of the handheld portion of the fan 5. In this way, a length of the wire is reduced, durability of the wire in improved, an aesthetic appearance of wires is improved. Wires can be arranged stably, an appearance of the wire arrangement is improved, and the durability is improved.

Embodiment 6-1, referring to FIGS. 6-1 to 6-6:

The present embodiment provides an airflow mechanism of a handheld fan. An airflow channel 11 is formed in an inner shell 1, and an air inlet 12 and an air outlet 13 are communicated to two sides of the airflow channel 11, respectively. A fan assembly 3 is received in the airflow channel 11. An outer shell 2 covers an outside of the inner shell 11 and is slidably connected to the inner shell 1 along a first axial direction. The first axial direction a direction extending from the air inlet 12 to the air outlet 13. During assembly, the outer shell 2 is pushed along the first axial direction to cover the inner shell 1, allowing the outer shell 2 to slidably cover the inner shell. For maintenance, the outer shell 2 may be slidably separated from the inner shell 1, such that the outer shell 2 may be disassembled easily. In this way, assembling and maintenance can be performed easily, assembly efficiency and maintenance convenience can be achieved, the assembly efficiency is improved, and the maintenance can be performed easily.

As shown in FIGS. 6-1 to 6-6, FIG. 6-1 is a structural schematic view of an airflow mechanism of the handheld fan according to an embodiment of the present disclosure; FIG. 6-2 is a structural schematic view of a shell 16 and a support bracket 17 of the airflow mechanism of the handheld fan according to an embodiment of the present disclosure; FIG. 6-3 is a structural schematic view of a limiting strip 21 in the airflow mechanism of the handheld fan according to an embodiment of the present disclosure; FIG. 6-4 is a structural schematic view of the air outlet 13 in the airflow mechanism of the handheld fan according to an embodiment of the present disclosure; FIG. 6-5 is a structural schematic view of the air inlet 12 in the airflow mechanism of the handheld fan according to an embodiment of the present disclosure; FIG. 6-6 is a structural schematic view of a sleeve 22 and an air inlet cover 23 in the airflow mechanism of the handheld fan according to an embodiment of the present disclosure.

For the inner shell 1:

In the inner shell 1, the airflow channel 11, the air inlet 12 communicated to one side of the airflow channel 11, and the air outlet 13 communicated to the other side of the airflow channel 11 are formed. The inner shell 1 includes a shell 16 and a plurality of support brackets 17 arranged on the shell 16. The plurality of support brackets 17 are slidably connected to the outer shell 2. The support brackets 17 of the inner shell 1 may define limiting grooves 14 that are mated with limiting strips 21 described below. The shell 16 of the inner shell 1 gradually expands along a direction from the air inlet 12 towards the air outlet 13. The plurality of support brackets 17 are disposed at an end of the shell 16 near the air inlet 12 and spaced apart from each other with an equal interval.

Specifically, the inner shell 1 includes the shell 16 and the plurality of support brackets 17 arranged on the shell 16. The shell 16 gradually expands along the direction from the air inlet 12 towards the air outlet 13, and that is, an inner diameter of an end of the shell 16 near the air inlet 12 is smaller than an inner diameter of the other end of the shell 16 near the air outlet 13. The airflow channel 11 formed inside the shell 16 of the inner shell 1 allows air to flow through. The air enters from the air inlet 12 into the airflow channel 11 and then exits the fan through the air outlet 13. A sleeve 22 in the outer shell 2 is arranged with a plurality of limiting strips 21 therein. The shell 16 of the inner shell 1 defines the plurality of limiting grooves 14 that are mated with the plurality of limiting strips 21. The limiting grooves 14 are defined in a surface of the shell 16 and are recessed towards the airflow channel 11. A space inside the limiting grooves 14 receives the limiting strips 21, allowing the limiting strips 21to be embedded in the limiting grooves 14. A snap groove 15 may be defined the support bracket 17 of the inner shell 1, and the support bracket 17 may provide support for the sleeve 22 of the outer shell 2. A snap head 24 arranged on an air inlet cover 23 of the outer shell 2 snaps into the snap groove 15. In this way, after the snap head 24 snaps into the snap groove 15, the air inlet cover 23 of the outer shell 2 may be connected to the support brackets 17 of the inner shell 1, such that the outer shell 2 may be easily disassembled from the inner shell 1.

For the outer shell 2 and the fan assembly 3:

The outer shell 2 covers the outside of the inner shell 1 and is slidably connected to the inner shell 1 along the first axial direction. The first axial direction is the direction extending from the air inlet 12 to the air outlet 13. The outer shell 2 is arranged with the plurality of limiting strips 21 that are mated with the plurality of limiting grooves 14. The plurality of limiting grooves 14 extend along the first axial direction, and the plurality of limiting strips 21 are slidably received in the plurality of limiting grooves 14. The plurality of limiting strips 21 and the plurality of limiting grooves 14 are in one to one correspondence with each other. Each of the plurality of limiting strips 21 is embedded in a respective one of the plurality of limiting grooves 14. The outer shell 2 includes the sleeve 22 and the air inlet cover 23. The sleeve 22 is arranged with the inner shell 1, and the plurality of limiting strips 21 are arranged on the sleeve 22. The air inlet cover 23 is detachably connected to the inner shell 1 and is connected to the sleeve 22. The inner shell 1 defines the snap groove 15, and the air inlet cover 23 is arranged with the snap head 24 that is mated with the snap groove 15. A plurality of snap heads 24 are disposed between the sleeve 22 and the inner shell 1 and are distributed along the first axial direction, and correspondingly, a plurality of snap grooves 15 are defined. The plurality of snap heads 24 and the plurality of snap grooves 15 are in one to one correspondence with each other. The plurality of snap heads 24 are spaced apart from each other with an equal interval. The fan assembly 3 is received in the airflow channel 11.

Specifically, the outer shell 2 has an internal space that receives the inner shell 1. The outer shell 2 includes the sleeve 22 and the air inlet cover 23. The limiting strips 21 are arranged on an inner wall of the sleeve 22 near the inner shell 1 and are align with the limiting grooves 14 defined in the inner shell 1. When the sleeve 22 of the outer shell 2 is slidably inserted from one end of the inner shell 1, the limiting strips 21 may be inserted and slide from openings of the limiting grooves 14 at an end. The limiting strips 21 may towards the other end of the limiting grooves 14, driving the sleeve 22 of the outer shell 2 to move along a length direction of the limiting grooves 14 defined in the inner shell 1.

Notably, the plurality of limiting strips 21 may refer to 1, 2, 3, or 4 limiting strips 21, and the plurality of limiting grooves 14 may refer to 1, 2, 3, or 4 limiting grooves 14. When 2 limiting grooves 14 are defined, the 2 limiting grooves 14 may be symmetrically distributed on two sides of the inner shell 1 and are parallel to each other. The 2 limiting strips 21 on the sleeve 22 of the outer shell 2 may slide in 2 corresponding limiting grooves 14. After the sleeve 22 is mounted on the inner shell 1, the 2 limiting strips 21 embedded in the 2 limiting grooves 14 limit the sleeve 22 from two sides thereof, enhancing stability of the sleeve 22 and facilitating the sleeve 22 to be slidably mounted on the inner shell 1. The fan assembly 3 includes a motor and fan blades driven by the motor. The motor may be mounted in the airflow channel 11 of the inner shell 1, and the shell 16 of the inner shell 1 supports the motor. A rotation shaft of the motor drives the fan blades to rotate, driving air to enter the airflow channel 11 from the air inlet 12 and to flow out of the fan through the air outlet 13. Since the outer shell 2 is connected to the handheld portion 4, the user may grip and carry the handheld fan easily.

The present embodiment provides the airflow mechanism of the handheld fan. The airflow channel 11 is formed in the inner shell 1, and the air inlet 12 and the air outlet 13 are communicated to two sides of the airflow channel 11, respectively. The fan assembly 3 is received in the airflow channel 11. The outer shell 2 covers the outside of the inner shell 11 and is slidably connected to the inner shell 1 along the first axial direction. The first axial direction the direction extending from the air inlet 12 to the air outlet 13. During assembly, the outer shell 2 is pushed along the first axial direction to cover the inner shell 1, allowing the outer shell 2 to slidably cover the inner shell. For maintenance, the outer shell 2 may be slidably separated from the inner shell 1, such that the outer shell 2 may be disassembled easily. In this way, assembling and maintenance can be performed easily, assembly efficiency and maintenance convenience can be achieved, the assembly efficiency is improved, and the maintenance can be performed easily.

In order to provide detailed description of the handheld fan provided by the present disclosure, the above Embodiment 6-1 provides a detailed description of the airflow mechanism of the handheld fan, and the present disclosure further provides a handheld fan based on a same concept, which will be described in detail in Embodiment 6-2.

### Embodiment 6-2

The present embodiment provides a handheld fan, including the airflow mechanism of the handheld fan described above.

The present embodiment provides the handheld fan. The airflow channel 11 is formed in the inner shell 1, and the air inlet 12 and the air outlet 13 are communicated to two sides of the airflow channel 11, respectively. The fan assembly 3 is received in the airflow channel 11. The outer shell 2 covers the outside of the inner shell 11 and is slidably connected to the inner shell 1 along the first axial direction. The first axial direction the direction extending from the air inlet 12 to the air outlet 13. During assembly, the outer shell 2 is pushed along the first axial direction to cover the inner shell 1, allowing the outer shell 2 to slidably cover the inner shell. For maintenance, the outer shell 2 may be slidably separated from the inner shell 1, such that the outer shell 2 may be disassembled easily. In this way, assembling and maintenance can be performed easily, assembly efficiency and maintenance convenience can be achieved, the assembly efficiency is improved, and the maintenance can be performed easily.

Embodiment 7, referring to FIGS. 7-1 to 7-9:

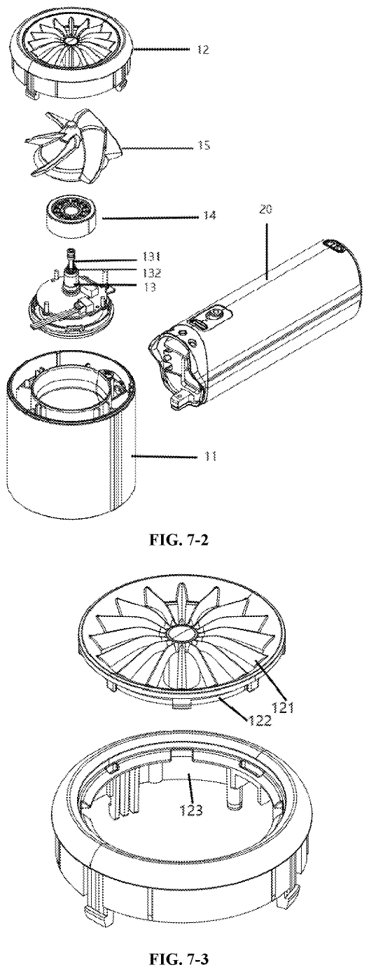

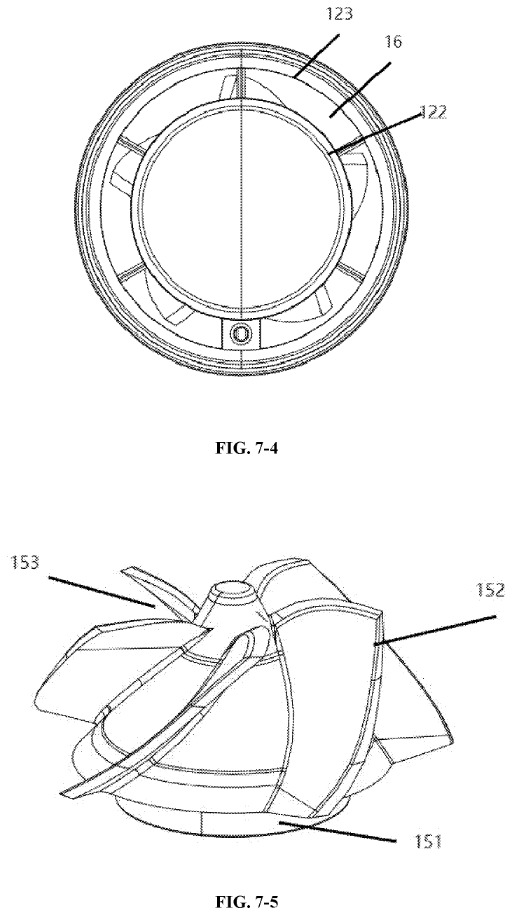

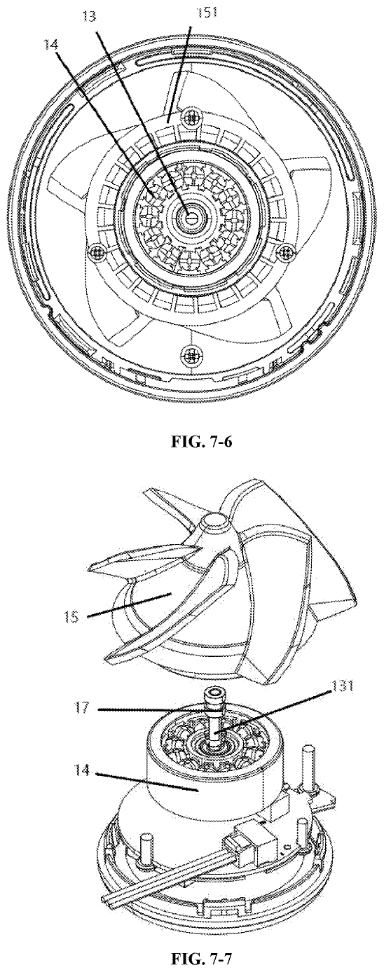

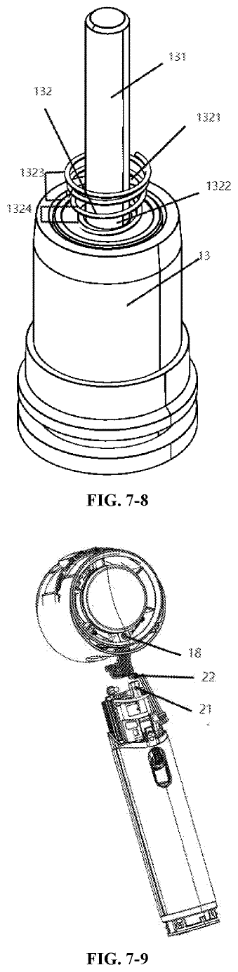

As shown in FIGS. 7-1 to 7-9, in order to reduce vibration and noise caused by oscillation of fan blades during high-speed rotation of the motor, the present disclosure provides a handheld fan, FIG. 7-1 is a structural schematic view of a handheld fan according to an embodiment of the present disclosure, including an airflow portion 10 and a handheld portion 20; FIG. 7-2 is an exploded view of the handheld fan according to an embodiment of the present disclosure, where the airflow portion 10 includes a shell 11, an air inlet cover 12 detachably connected to the shell 11, and a motor 13 arranged inside the shell 11. A motor shaft 131 is received in a shaft hole of the motor 13 and can rotate relative to the motor 13. A top of the motor shaft 131 is connected to fan blades 15. A vibration damping spring 132 is disposed between the motor 13 and the fan blades 15 and sleeves the motor shaft 131.

As shown in FIG. 7-3, FIG. 7-3 is a structural schematic view of the air inlet cover according to an embodiment of the present disclosure, the air inlet cover 12 includes an air inlet plate 121, a first side wall 122 connected to the air inlet plate 121 and surrounding a preset axis, and a second side wall 123 surrounding a periphery of the first side wall 122. FIG. 7-4 is a structural schematic view of formation of an air duct according to an embodiment of the present disclosure. The air duct 16 is formed between the first side wall 122 and the second side wall 123. A minimum inner diameter of the second side wall 123 is greater than a maximum outer diameter of the first side wall 122, ensuring a width of the air duct between the second side wall 123 and the first side wall 122, ensuring an air outputting area and reducing an airflow resistance of the second side wall 123. The airflow in the air duct can be guided properly, such that a high air outputting efficiency is achieved, and the airflow can be output more smoothly.

Specifically, when the user is using the handheld fan, the fan blades 15 are driven by the motor 13 to rotate, guiding the air from the air inlet cover 12 into a space between the first side wall 122 and the second side wall 123 and blowing the air out of the fan from the air outlet. The user may hold the handheld fan to direct the airflow to flow towards a desired cooling region, such that the region may be cooled quickly, and the usage experience is improved.

FIG. 7-5 is a structural schematic view of fan blades according to an embodiment of the present disclosure. The fan blades 15 include a conical cavity 151 and blades 152 arranged on an outer side of the conical cavity 151. The blades 152 are configured in a diagonal flow shape. A diagonal flow channel 153 is formed between every two adjacent blades 152. The diagonal flow channel 153 guides the air from the air inlet cover 12 into the air duct 16 formed between the first side wall 122 and the second side wall 123, reducing an impact performed by the airflow on an inner wall of the air inlet cover, minimizing an airflow loss, and improving an airflow outputting efficiency. In the present embodiment, the blades 152 of the handheld fan are configured in the diagonal flow shape, increasing the air volume, reducing noise, and providing a more compact structure, such that the fan may be easily held and carried.

FIG. 7-6 is a bottom view of the airflow portion according to an embodiment of the present disclosure. A motor bearing 14 is arranged to sleeve the motor 13 and is received in the conical cavity 151. The motor bearing 14 ensures stability of the motor 13 during high-speed rotation, such that the overall handheld fan may operate stably.

FIG. 7-7 is a structural schematic view of a motor shaft and fan blades being integrally formed according to an embodiment of the present disclosure. The motor shaft 131 and the fan blades 15 are integrally formed as a one-piece structure. A metal ring 17 is fixedly arranged between the motor shaft 131 and the fan blades 15. The metal ring 17 passes through the motor shaft 131 to secure the motor shaft 131 and the fan blades 15. The integral formation of the fan blades 15 and the motor shaft 131 effectively reduces a space occupied by the airflow portion 10.

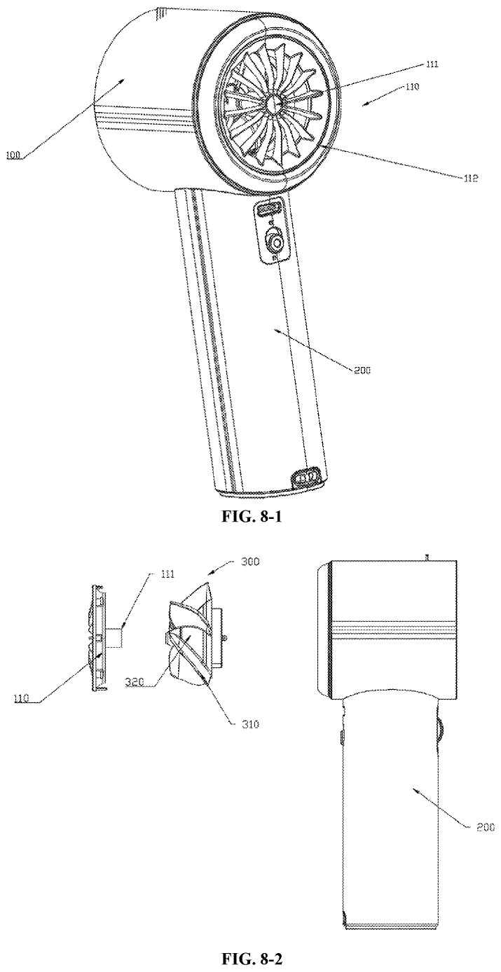

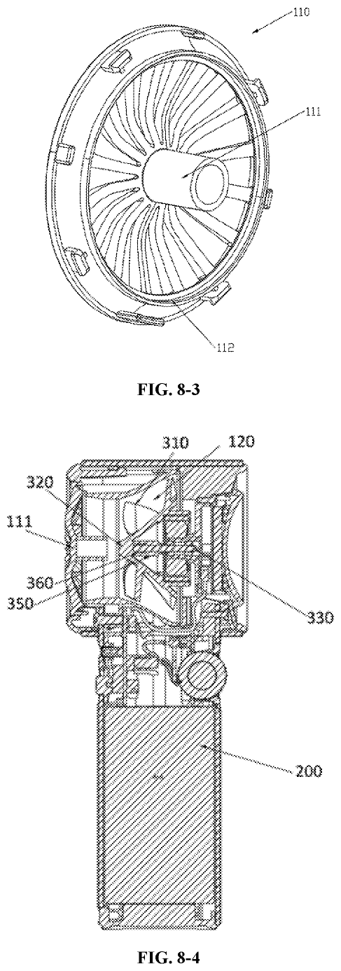

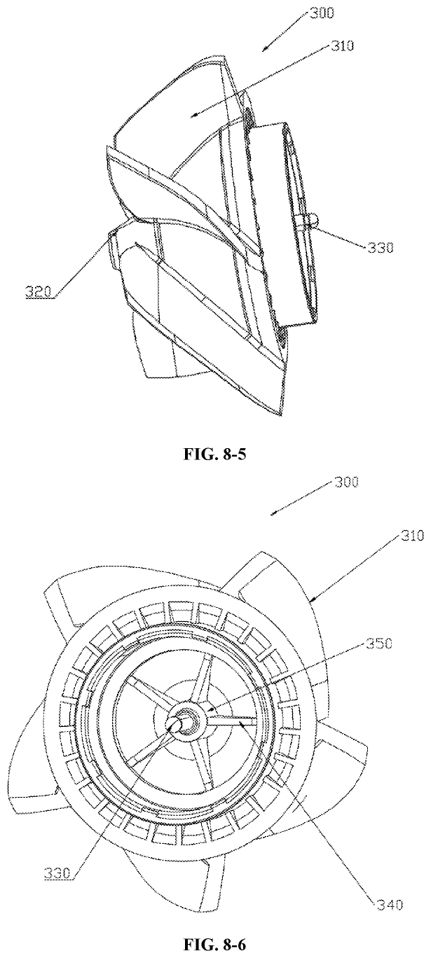

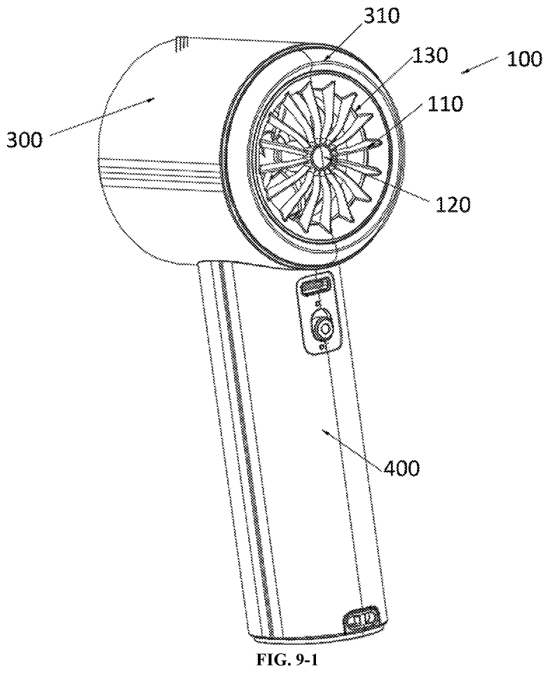

FIG. 7-8 is a structural schematic view of a vibration damping spring according to an embodiment of the present disclosure. The vibration damping spring 132 is detachably connected to the motor shaft 131, allowing the vibration damping spring 132 to be easily replaced when being damaged. In addition, since desired damping strengths at various positions may be different from each other, an inner diameter of the vibration damping spring 132 and spacings between every two adjacent coils of the spring may vary accordingly.

Specifically, an inner diameter 1321 of an end of the vibration damping spring 132 away from the motor 13 is greater than an inner diameter 1322 of the other end of the vibration damping spring 132 near the motor 13. Spacings 1323 between adjacent coils at the end of the vibration damping spring 132 away from the motor 13 is smaller than spacings 1324 between adjacent coils at the other end of the vibration damping spring 132 near the motor 13.

FIG. 7-9 is a structural schematic view of the handheld portion and the airflow portion according to an embodiment of the present disclosure. The airflow portion 10 includes a first connecting member 18, and the handheld portion 20 includes a second connecting member 21. The airflow portion 10 and the handheld portion 20 are connected to each other via a fixing member 22. The fixing member passes through the first connecting member 18 and the second connecting member 21 to connect the airflow portion 10 and the handheld portion 20. For example, the fixing member 22 can be a screw or any other fixing member used to connect the airflow portion 10 with the handheld portion 20. The present embodiment does not limit a type of the fixing member.

The present embodiment provides a handheld fan, including the airflow portion and the handheld portion. The airflow portion includes the shell, the air inlet cover detachably connected to the shell, and the motor arranged inside the shell. The motor has the shaft hole receiving the motor shaft, which can rotate relative to the motor. The top of the motor shaft is connected to the fan blades. The vibration damping spring is arranged between the motor and the fan blades, sleeving the motor shaft.

The handheld fan generates reduced vibration and noise caused by oscillation of the fan blades during high-speed rotation of the motor, such that a better user experience is provided.

Embodiment 8, referring to FIGS. 8-1 to 8-6:

As shown in FIG. 8-1, the present embodiment provides a handheld fan including an airflow portion 100, a handheld portion 200, and an airflow assembly 300. The handheld portion 200 is connected to the airflow portion 100.

As shown in FIG. 8-2, the airflow portion 100 includes an air inlet cover 110.

As shown in FIG. 8-3, the air inlet cover 110 includes an air inlet cover body 112 and an air guiding portion 111 connected to the air inlet cover body 112 and extending towards the airflow assembly 300. The airflow portion 100 includes a first receiving cavity 120.

FIG. 8-4 is a cross-sectional view of the handheld fan, taken along a line A-A; and FIG. 8-5 is a perspective view of the airflow assembly 300 of the handheld fan being viewed from a viewing angle. The airflow assembly 300 is received in the first receiving cavity 120. An air guiding cone 320 and fan blades 310 arranged on the air guiding cone 320 are received in the first receiving cavity 120. A first gap is formed between the air guiding cone 320 and the air guiding portion 111.

Specifically, the air inlet cover body 112 may be any member that operates cooperatively with the air guiding portion 111 to guide air. For example, the air inlet cover body 112 may be an assembly for guiding air, such as an air guiding plate or air guiding holes. The air inlet cover body 112 may be a base structure that supports the air guiding portion 111 of the air inlet cover 110, enhancing overall stability of the air inlet cover 110. Therefore, a specific structure of the air inlet cover body 112 is not specifically limited, and any ordinary skilled person in the art may determine the structure of the air inlet cover body 112 according to specific needs.

Specifically, the airflow assembly 300 may be a fan motor module. The air guiding cone 320 may be driven by a motor to rotate, such that the fan blades 310 arranged on the air guiding cone 320 may rotate accordingly. In this way, the air entering the first receiving cavity 120, which enters the fan through the air inlet cover 110, may be delivered out of the airflow portion 100 as the fan blades 310 rotate.

It can be understood that the air guiding cone 320 may be conical or truncated conical. For example, the air guiding cone 320 may be a side wall surrounding a certain axis, and an inner diameter of the side wall gradually decreases or increases from one end to the other end.

Specifically, the fan blades 310 may be diagonal flow blades, allowing air to flow along a surface of the air guiding cone 320 and flow through air channels formed between adjacent fan blades 310.

Specifically, the handheld portion 200 may be any structure used to hold the fan, which will not be limited herein.

When no gap is formed between the airflow assembly 300 and the air guiding portion 111 of the air inlet cover 110 extending towards the airflow assembly 300, airflow entering from the air inlet cover 110 forms turbulence, causing flowing air to interfere with each other to generate significant noise. Therefore, in the present embodiment, a gap is formed between the air guiding cone 320 arranged with the fan blades 310 and the air guiding portion 111, turbulence generated by the airflow entering from the air inlet cover 110 may be reduced, such that interference between the flowing air is reduced, and the noise generated by the airflow is reduced.

In an embodiment, as shown in FIG. 8-4, the first gap is greater than 1 mm and less than 14 mm.

It can be understood that by forming the gap between the air guiding cone 320 and the air guiding portion 111, the turbulence between the air guiding cone 320 and the air guiding portion 111 can be effectively reduced. However, when the gap distance between the air guiding cone 320 and the air guiding portion 111 is excessively large, a length of the air channel may be increased, prolonging an air flowing time length from the air inlet cover 110 to the air outlet, such that the air outputting efficiency of the fan is reduced. Therefore, the gap between the air guiding cone 320 and the air guiding portion 111 is between 1 mm and 14 mm, ensuring a proper air outputting efficiency and effectively reducing turbulence and minimizing noise.

In an embodiment, as shown in FIGS. 8-4 and 8-5, the fan blades 310 are located between two end surfaces of the air guiding cone 320.

It can be understood that by arranging the fan blades 310 between the two end surfaces of the air guiding cone 320, the fan blades 310 are prevented from being extending out of the two end surfaces of the air guiding cone 320, such that obstacles, which may cause turbulence between the air guiding cone 320 and the air guiding portion 111, may be prevented, and noise can be avoided.

In an embodiment, as shown in FIG. 8-3, the air guiding portion 111 is columnar. One end of the air guiding portion 111 is received in the first receiving cavity 120. A first gap is formed between the end of the air guiding cone 320 near the air inlet cover 110 and an end of the air guiding portion 111 near the air guiding cone 320.

Specifically, in the present embodiment, the air guiding portion 111 can be a cylinder, a triangular prism, a cube, or a rectangular prism. Configuring the air guiding portion 111 in various shapes allows the air entering the first receiving cavity 120 to flow along the surface of the air guiding portion 111, such that the air entering the first receiving cavity 120 can be guided. Therefore, in practice, a specific shape of the air guiding portion 111 may be determined according to specific needs.

It can be understood that a length of the air guiding portion 111 extending into the first receiving cavity 120 is determined by a value of the first gap. As the first gap increases, the length of the air guiding portion 111 extending into the first receiving cavity 120 descreases, and vice versa.

In an embodiment, as shown in FIGS. 8-2 and 8-4, an end surface of the air guiding cone 320 near the air inlet cover 110 is circular, and a diameter of the end surface of the air guiding cone 320 near the air inlet cover 110 is smaller than a diameter of a circumcircle of the end surface of the air guiding portion 111.

It can be understood that, compared to the end surface of the air guiding cone 320 near the air inlet cover 110 being a point, the end surface of the air guiding cone 320 near the air inlet cover 110 being circular may improve structural stability of the air guiding cone 320.

It can be understood that the end surface of the air guiding portion 111 may be square, triangular, or circular, which will not be limited herein.

In some embodiments, an axis of the air guiding cone 320 coincides with an axis of the air guiding portion 111. When the diameter of the circumcircle of the end surface of the air guiding portion 111 is greater than the diameter of the end surface of the air guiding cone 320 near the air inlet cover 110, the air, which flows along the surface of the air guiding portion 111 towards the air duct formed by the air guiding cone 320 and the fan blades 310, may not be blocked by the end surface of the air guiding cone 320. Therefore, all air guided by the air guiding portion 111 can be directed into the air duct to improve the air outputting efficiency of the fan.

In an embodiment, as shown in FIG. 8-6, the airflow assembly 300 further includes a rotation shaft 330 received in an inner cavity of the air guiding cone 320. The rotation shaft 330 drives the air guiding cone 320 to rotate around a preset axis, and the preset axis is an air flowing direction of the airflow portion 100.

Specifically, the air guiding cone 320 may be hollow to have the inner cavity. By arranging the rotation shaft 330 in the inner cavity of the air guiding cone 320, a space is effectively utilized, and the rotation shaft 330 is prevented from being arranged outside the air guiding cone 320, such that turbulence is prevented.

In an embodiment, as shown in FIGS. 8-4 and 8-6, the airflow assembly 300 further includes a plurality of support plates 340 connected between an inner wall of the air guiding cone 320 and the rotation shaft 330.

It can be understood that mounting the plurality of support plates 340 between the inner wall of the air guiding cone 320 and the rotation shaft 330 enhances stability and firmness of connection between the air guiding cone 320 and the rotation shaft 330.

Further, in some embodiments, in order to increase connection stability between the air guiding cone 320 and the rotation shaft 330, the plurality of support plates 340 may be arranged around a periphery of the rotation shaft 330. In addition, the plurality of support plates 340 may be evenly distributed around the rotation shaft 330 to further enhance the connection stability between the air guiding cone 320 and the rotation shaft 330.

In an embodiment, as shown in FIGS. 8-4 and 8-6, the airflow assembly 300 further includes a sleeve 350 sleeving an outside of the rotation shaft 330. The support plates 340 are connected to the rotation shaft 330 via the sleeve 350.

In some embodiments, an end of the sleeve 350 may be connected to an end of the air guiding cone 320 connected to the rotation shaft 330. Since the rotation shaft 330 drives the air guiding cone 320 to rotate, connecting the sleeve 350 between the support plates 340 and the rotation shaft 330 provides vibration damping for the support plates 340, ensuring the connection stability between the support plates 340 and the air guiding cone 320.

In an embodiment, as shown in FIGS. 8-4 and 8-6, the rotation shaft 330, the sleeve 350, and the air guiding cone 320 are integrally formed.

It can be understood that the integral formation of the sleeve 350 and the rotation shaft 330 ensures connection stability between the sleeve 350 and the rotation shaft 330.

Specifically, a first end of the air guiding cone 320 near the air inlet cover 110 may be closed, and an end of the rotation shaft 330 may be integrally formed with the first end of the air guiding cone 320, enhancing connection stability between the air guiding cone 320 and the rotation shaft 330.

In an embodiment, as shown in FIGS. 8-2 and 8-4, the diameter of the circumcircle of the end surface of the air guiding portion 111 is greater than 5 mm and less than 12 mm.

The end surface of the air guiding cone 320 near the air inlet cover 110 is circular, and the diameter of the end surface of the air guiding cone 320 near the air inlet cover 110 is greater than 1 mm and less than 7 mm.

It can be understood that, when the diameter of the circumcircle of the end surface of the air guiding portion 111 is larger than the diameter of the end surface of the air guiding cone 320 near the air inlet cover 110, the air, which flows along the surface of the air guiding portion 111 and towards the air duct formed by the air guiding cone 320 and the fan blades 310, may not be blocked or minimally blocked by the end surface of the air guiding cone 320 near the air inlet cover 110. In this way, most of the air guided by the air guiding portion 111 is guided into the air duct to improve the air outputting efficiency of the fan.

In addition, when the diameter of the circumcircle of the end surface of the air guiding portion 111 is large, the air guiding portion 111 serves as a support for the air inlet cover body 112, and stability of the air inlet cover body 112 is improved. When the diameter of the end surface of the air guiding cone 320 near the air inlet cover 110 is small, a size of the air guiding cone 320 is reduced, such that the air guiding cone 320 may occupy a reduced space in the first receiving cavity 120, and a size of the air duct formed in the airflow portion 100 is increased. In this way, a larger volume of air can be output through the airflow portion 100, improving the air outputting efficiency of the fan.

In an embodiment, as shown in FIGS. 8-4, the airflow assembly 300 further includes a sleeve ring 360 surrounding the rotation shaft 330. The sleeve ring 360 is disposed between the rotation shaft 330 and the sleeve 350.

It can be understood that the sleeve ring 360 disposed between the rotation shaft 330 and the sleeve 350 enhances firmness of the connection between the rotation shaft 330 and the sleeve 350, preventing slippage and increasing structural strength of the rotation shaft 330.

In an embodiment, as shown in FIG. 8-4, the sleeve ring 360 and the rotation shaft 330 are integrally formed as a one-piece structure.

It can be understood that the integral formation of the sleeve ring 360 and the rotation shaft 330 enhances stability of sleeved connection between the sleeve ring 360 and the rotation shaft 330 and further increases the structural strength of the rotation shaft 330.

Embodiment 9, referring to FIGS. 9-1 to 9-5:

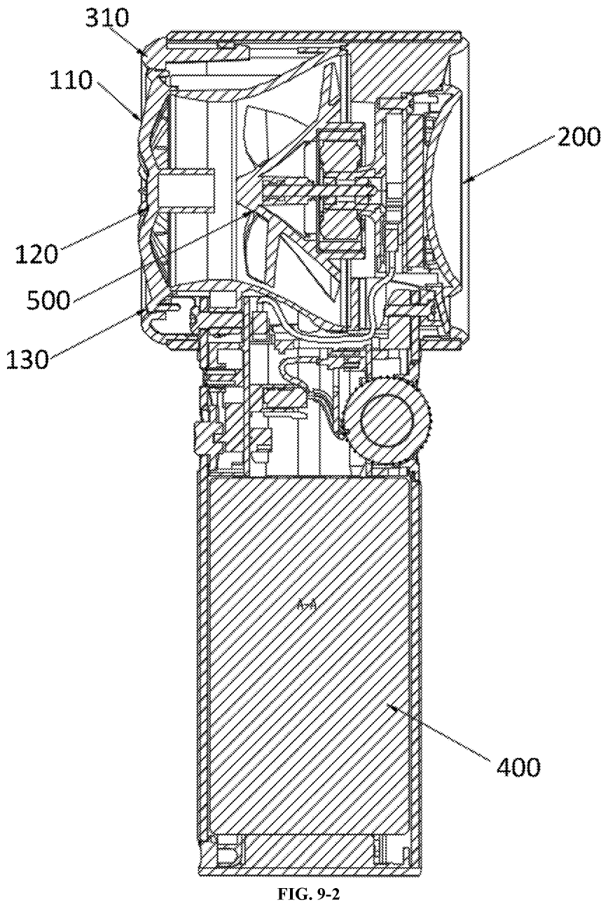

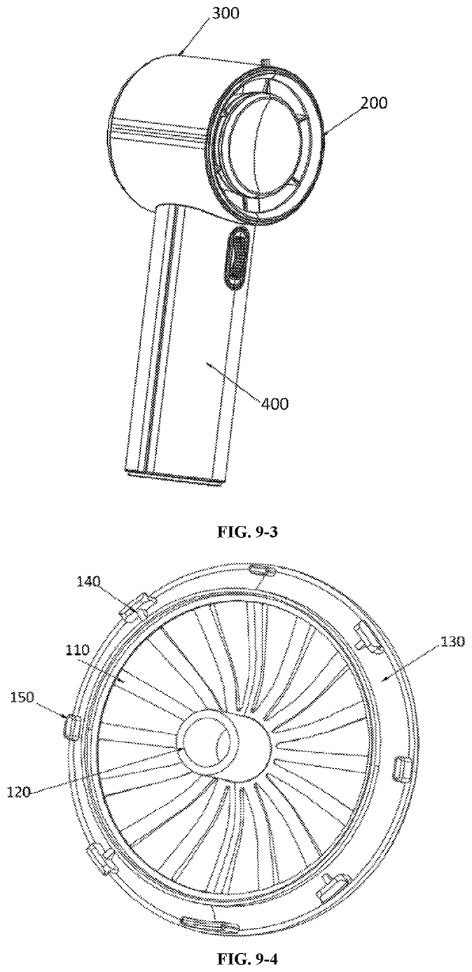

As shown in FIGS. 9-1 to 9-3, FIG. 9-1 is a perspective view of a handheld fan according to an embodiment of the present disclosure; FIG. 9-2 is a cross-sectional view of the handheld fan, taken along a line A-A, according to an embodiment of the present disclosure; and FIG. 9-3 is another perspective view of the handheld fan according to an embodiment of the present disclosure. The handheld fan includes: an air inlet cover 100, an air outlet cover 200, a first housing 300, a handle portion 400, and a fan module 500. The air inlet cover 100 includes a plurality of air guiding plates 110 that are connected to each other and are arranged radially around a preset axial direction. The preset axial direction is an axial direction extending from the air inlet cover 100 to the air outlet cover 200. An air intake gap is defined between every two adjacent air guiding plates 110. Each of the plurality of air guiding plates 110 protrudes away from the air outlet cover 200.

The first housing 300 is connected between the air inlet cover 100 and the air outlet cover 200. The first housing 300, the air inlet cover 100 and the air outlet cover 200 cooperatively define a first receiving cavity.

An end of the handle portion 400 is connected to the first housing 300.

The fan module 500 is received in the first receiving cavity.

Specifically, the air inlet cover 100 and the air outlet cover 200 may be disposed opposite to each other to ensure an airflow channel to have a high efficiency of guiding an airflow.

Specifically, connection of plurality of air guiding plates 110 may be achieved by connecting first ends of the plurality of air guiding plates 110 to each other and connecting second ends of the plurality of air guiding plates 110 to each other.

Specifically, the handle portion 400 may be any structure that can be held by hand, which is not limited herein.

Specifically, the fan module 500 may be configured as any type of fan, such as an axial fan, a centrifugal fan, a mixed-flow fan, which is not limited herein.

It can be understood that the connection may be integral molding or connection via a connecting member, which is not limited here.

In the present embodiment, the air guiding plates 110 of the air inlet cover 100 protrude away from the air outlet cover 200, and the air guiding plates 110 are connected to each other and are arranged radially around the preset axial direction, such that the air inlet cover 100 is in overall protrude away from the air outlet cover 200. Compared to a situation where the air inlet cover is flat or concave away from the air outlet cover 200, the configuration in the present embodiment effectively increases an air intaking volume of the air inlet cover 100. Therefore, when the fan module 500 in the first receiving cavity operates, an increased volume of air can be drawn into the first receiving cavity through the air inlet cover 100 and delivered out the fan through the air outlet cover 200. In this way, an air intaking efficiency of the air inlet cover 100 and an air outputting efficiency of the air outlet cover 200 are improved, and a cooling efficiency of the handheld fan is improved.

In an embodiment, FIG. 9-4 is a perspective view of the air inlet cover 100 of the handheld fan according to an embodiment of the present disclosure. The air inlet cover 100 further includes a first base 120 and a ring 130 that is surrounding the preset axial direction and is arranged on a periphery of the first base 120. A first end of the first base 120 away from the air outlet cover 200 is a closed end, and the other end of the first base 120 is an open end.

Specifically, the plurality of air guiding plates 110 are connected between the first base 120 and the ring 130, ensuring connection stability of between the air guiding plates 110. Furthermore, since the air guiding plates 110 surrounds and are arranged on the first base 120, connection between the air guiding plates 110 and the first base 120 ensures structural stability of the entire air inlet cover 100.

It can be understood that the closed first end of the first base 120 away from the air outlet cover 200 prevents air from entering an inner cavity of the first base 120. In this way, when the fan module 500 is operating, an impact on the first base 120, caused by a high air speed from the air inlet cover 100, can be avoided, and structural instability of the air inlet cover 100, caused by any impact on the first base 120, may be prevented.

In an embodiment, as shown in FIG. 9-4, the first base 120 is a hollow cylinder.

It can be understood that configuring the first base 120 to be hollow effectively reduces a weight of the handheld fan, increasing portability of the handheld fan. In addition, configuring the first base 120 to be hollow saves material for the first base 120, reducing manufacturing costs.

It can be understood that since the air guiding plates 110 are arranged around and disposed between the first base 120 and the ring 130, configuring the first base 120 to be the cylinder ensures that the plurality of air guiding plates 110 have a same shape and a same length. It is further ensured that air is uniformly distributed through the air inlet cover 100, and the air is uniformly output from the air outlet cover 200, avoiding uneven air output and improving user experience.

In an embodiment, as shown in FIG. 9-4, an end surface of the first end of the first base 120 is recessed inwardly with respect to an end surface of the ring 130 away from the air outlet cover 200.

It should be noted that the recessed end surface of the first base 120 refers to the end surface protruding towards the air outlet cover 200.

It can be understood that the recessed end surface of the first base 120 is recessed inwardly with respect to the end surface of the ring 130 away from the air outlet cover 200, and the air guiding plates 110 are connected between the first base 120 and the ring 130 and protrude towards the side away from the air outlet hood 200. Therefore, a protrusion amount of the air inlet cover 100 protruding towards the side away from the air outlet cover 200 is increased, the air intake area of the air inlet cover 100 is increased without changing a size of the handheld fan, the air intaking efficiency and the cooling efficiency of the handheld fan are improved.

In an embodiment, as shown in FIGS. 9-4, an inner diameter of the ring 130 is greater than an outer diameter of the first base 120, and the inner diameter of the ring 130 gradually decreases along an air outputting direction.

It can be understood that, as the inner diameter of the ring 130 is greater than the outer diameter of the first base 120, an air inlet channel is formed between the ring 130 and the first base 120, such that the air may enter the first receiving cavity through the air inlet channel. The gradually decreasing inner diameter of the ring 130 along the air outputting direction compresses the intaken air, increasing an air pressure and an air speed at the air inlet cover 100, improving the air intaking efficiency of the handheld fan.

In an embodiment, as shown in FIG. 9-4, the plurality of air guiding plates 110 are evenly distributed and are arranged around the first base 120 and are connected between the ring 130 and the first end of the first base 120.

It can be understood that evenly distributing the plurality of air guiding plates 110 around the first base 120 ensures an equal gap is formed between every two adjacent air guiding plates 110. Evenly distributing the plurality of air guiding plates 110 around the first base 120 enables the air inlet cover 100 to intake air more uniformly and stably, avoiding uneven air output and improving user experience.

Connecting the plurality of air guiding plates 110 between the ring 130 and the first end of the first base 120 prevents a part of the first base 120 from being disposed outside the first receiving cavity, such that the size of the handheld fan is not increased, and the handheld fan is more portable.

In an embodiment, as shown in FIG. 9-4, a width of each air guiding plate 110 gradually decreases along a direction from a periphery of the air inlet cover 100 towards a center of the air inlet cover 100.

It can be understood that the width of the air guiding plate 110 ensures structural stability during air guiding, and the gradually decreased width of the air guiding plate 110 saves material, such that manufacturing costs are reduced.

In an embodiment, as shown in FIG. 9-4, the first base 120, the ring 130, and the plurality of air guiding plates 110 are integrally formed as a one-piece structure.

It can be understood that the integral formation of the first base 120, the ring 130, and the plurality of air guiding plates 110 ensures structural stability of the air inlet cover 100 when the air inlet cover 100 is subject to an air inlet impact, such that the air intaking efficiency of the handheld fan is ensured.

In an embodiment, FIG. 9-5 is a perspective view of a first side wall of the handheld fan according to an embodiment of the present disclosure, and in combination with FIGS. 9-1 and 9-4, the first housing 300 includes a first side wall 310 surrounding the periphery of the air inlet cover 100 along the preset axial direction.

An inner edge of the air inlet cover 100 is arranged with a plurality of first snaps 140.

An end of the first side wall 310 near the air inlet cover 100 defines first through holes 311 mated with the first snaps 140. Openings of the first through holes 311 are defined in a side away from the first side wall 310.

Each first snap 140 includes an insertion portion. A second end of the insertion portion is bent to form a chamfer and is disposed away from the air inlet cover 100.

By inserting the insertion portion along the air intaking direction into the first through hole 311 and snapping the chamfer with the inner wall of the first side wall 310, the first side wall 310 is connected to the air inlet cover 100.

It can be understood that an inner side of the air inlet cover 100 and an inner side of the first side wall 310 are sides near the first receiving cavity.

In some embodiments, as shown in FIGS. 9-4 and 9-5, a side edge of the first side wall 310 near the air inlet cover 100 may be arranged with a chamfered surface 313. The chamfered surface 313 extends towards the center of the air inlet cover 100. Connection between the first side wall 310 and the air inlet cover 100 is achieved through the chamfered surface 313 being connected to the air inlet cover 100. Specifically, in the present embodiment, the first through hole 311 may be defined in the chamfered surface 313 of the first side wall 310, such that the first snap 140 arranged on the inner edge of the air inlet cover 100 may be disposed on the inner side of the ring 130. By inserting the first snap 140 into the first through hole 311 and snapping the chamfer with the inner wall of the chamfered surface 313 of the first side wall 310, the air inlet cover 100 is connected to the first side wall 310 from the inside of the first receiving cavity. In this way, a connection structure between the air inlet cover 100 and the first side wall 310 is prevented from being damaged if the air inlet cover 100 and the first side wall 310 are connected to each other from the outside, such that integrity of the air inlet cover 100 and the first side wall 310 is ensured.

In an embodiment, as shown in FIGS. 9-4 and 9-5, the inner edge of the air inlet cover 100 is further arranged with a plurality of first insertion members 150.

An inner side of an end of the first side wall 310 near the air inlet cover 100 defines a plurality of second through holes 312 mated with the plurality of first insertion members 150.

By inserting and fixing the first insertion members 150 into the second through holes 312, the air inlet cover 100 and the first side wall 310 are connected to each other.

It can be understood that the inner side of the air inlet cover 100 and the inner side of the first side wall 310 are sides near the first receiving cavity.

In some embodiments, as shown in FIGS. 9-4 and 9-5, an edge of an end of the first side wall 310 near the air inlet cover 100 is arranged with the chamfered surface 313. The chamfered surface 313 extends towards the center of the air inlet cover 100. Connection between the first side wall 310 and the air inlet cover 100 is achieved through the chamfered surface 313 being connected to the air inlet cover 100. Specifically, in the present embodiment, the first through hole 311 may be defined in the chamfered surface 313 of the first side wall 310, such that the first snap 140 arranged on the inner edge of the air inlet cover 100 may be disposed on the inner side of the ring 130. By inserting the first snap 140 into the first through hole 311 and snapping the chamfer with the inner wall of the chamfered surface 313 of the first side wall 310, the air inlet cover 100 is connected to the first side wall 310 from the inside of the first receiving cavity. In this way, a connection structure between the air inlet cover 100 and the first side wall 310 is prevented from being damaged if the air inlet cover 100 and the first side wall 310 are connected to each other from the outside, such that integrity of the air inlet cover 100 and the first side wall 310 is ensured.

Embodiment 10, referring to FIGS. 10-1 to 10-8:

As shown in FIGS. 10-1 to 10-8, a handheld fan is provided and can be easily disassembled and assembled, maintenance may be performed conveniently, and a service life of the handheld fan is extended.

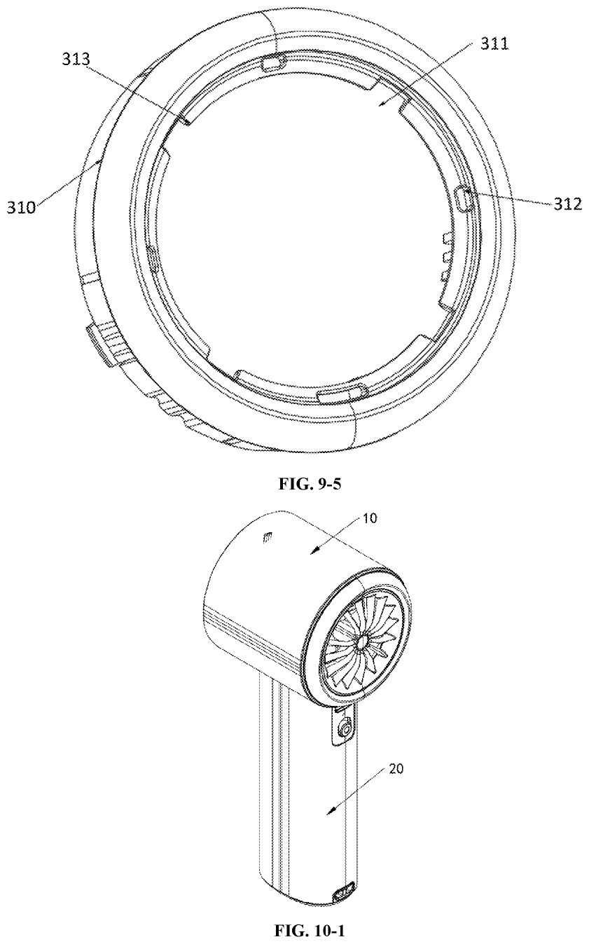

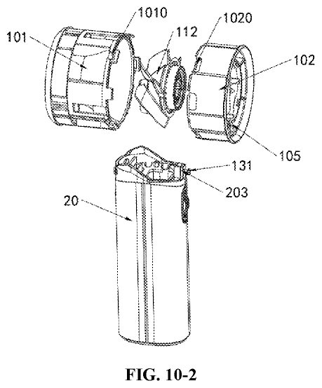

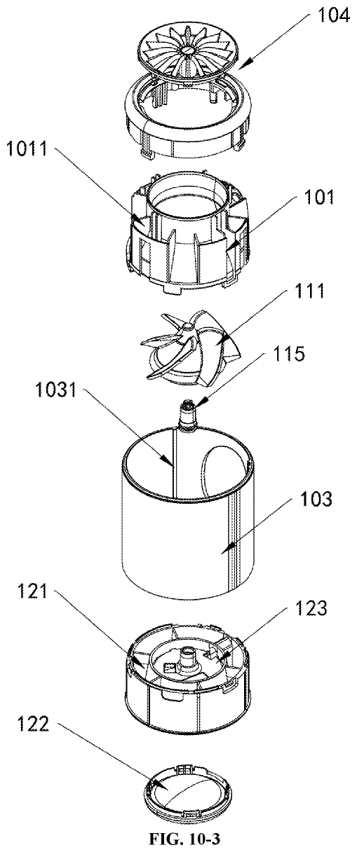

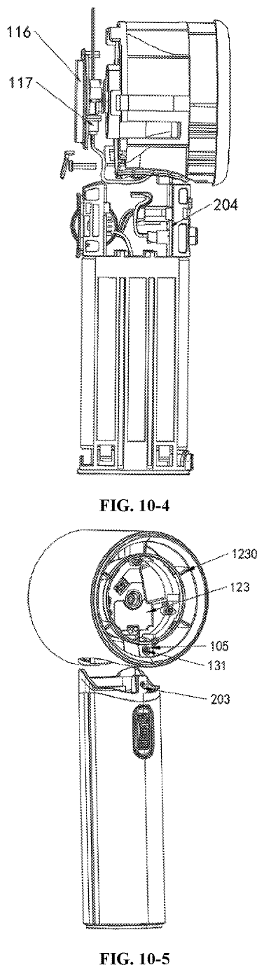

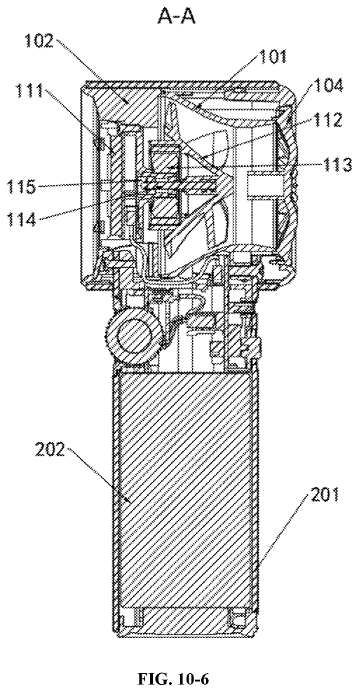

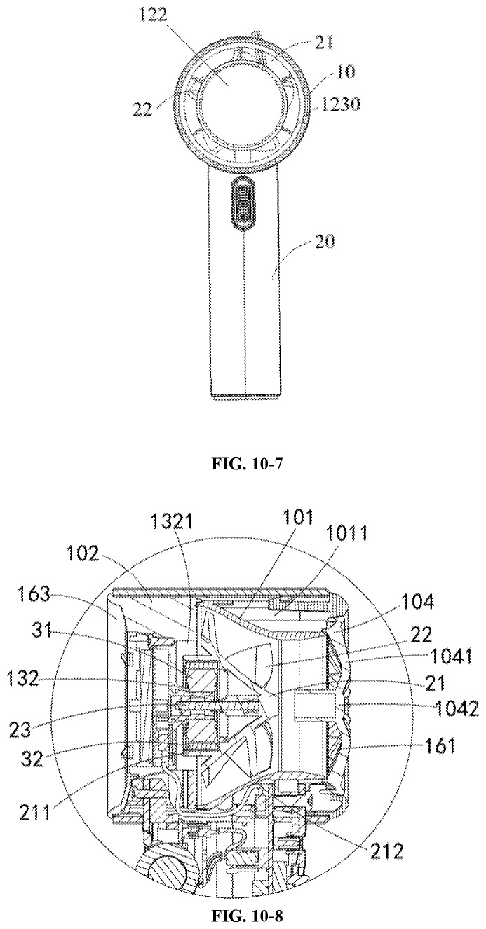

Specifically, as shown in FIG. 10-1, FIG. 10-1 is a perspective view of the handheld fan according to an embodiment of the present disclosure. The handheld fan includes: an airflow portion 10 and a handheld portion 20 detachably connected to the airflow portion 10. As shown in FIGS. 10-2 to 10-3, the airflow portion 10 includes a second inner shell 101, a first inner shell 102 engaged with the second inner shell 101, and an outer shell 103. A side of the second inner shell 101 facing the first inner shell 102 is arranged with a plurality of protruding structures 1010 that are distributed evenly. The first inner shell 102 defines a plurality of recessed structures 1020 corresponding to the plurality of protruding structures 1010. The protruding structures 1010 are engaged with the recessed structures 1020 correspondingly. The outer shell 103 covers the second inner shell 101 and the first inner shell 102 to receive the second inner shell 101 and the first inner shell 102. By arranging the protruding structures 1010 on the outer wall edge of the second inner shell 101 facing the first inner shell 102 and the corresponding recessed structures 1020 on the first inner shell 102, the protruding structures 1010 can be tightly engaged with the recessed structures 1020, ensuring tight connection between the second inner shell 101 and the first inner shell 102 and facilitating easy assembling and disassembling between the second inner shell 101 and the first inner shell 102. By arranging the protruding structures 1010 and the recessed structures 1020, the second inner shell 101 and the first inner shell 102 may be easily to disassembled and assembled when maintenance is needed, and maintenance may be performed conveniently.

Further, a fan base 111 is arranged inside the first inner shell 102, and a fan impeller 112 is arranged on a side (referred to as a first side, the first side is also the air inlet side, i.e., facing towards the air inlet 161) of the fan base 111 facing the second inner shell 101. The fan impeller 112 is arranged with a conical cavity. A bearing 115 is received in the conical cavity. A motor rotation shaft 114 is arranged inside the bearing 115 and is connected to the bearing 115. The bearing 115 surrounds a periphery of the motor shaft 114. When the motor rotation shaft 114 rotates, the bearing 115 effectively reduces an axial offset caused by rotation of the motor rotation shaft 114, ensuring the stability of the motor shaft 114 during rotation and overall stability of the handheld fan during operation.

Specifically, a side of the fan base 111 defines a receiving cavity 123, and an air outlet portion 121 is arranged between an outside of the receiving cavity 123 (also the outside of the fan base 111) and an inner side of the first inner shell 102. Connecting plates 1230 are arranged on an outer wall of the receiving cavity 123 and are spaced apart from each other. The connecting plates 1230 are connected to an inner wall of the first inner shell 102, i.e., the connecting plates 1230 is set in the air outlet portion 121, and the air outlet portion 121 is in communication with the air outlet 163. The connecting plates 1230 enhance stability between the first inner shell 102 and the receiving cavity 123, improving stability of the fan base 111 during operation, and the airflow driven by the fan impeller 112 blows out the air outlet 163 through the gap between each pair of adjacent connecting plates 1230.

Further, as shown in FIG. 10-4, a first circuit board 116 is arranged at a rear side of the fan base 111, a second circuit board 204 is arranged inside the handheld portion 20. The fan base 111 defines a first wire channel 117 in a radial direction thereof. The first wire channel 117 is configured to receive wires connecting from the first circuit board 116 to the second circuit board 204. The wires are led out from the first circuit board 116 to the second circuit board 204. The handheld portion 20 is arranged with the second circuit board 204, facilitating wire arrangement. The first wire channel 117 ensures that the wires are not easily bent when connecting circuit boards, extending a service life of the wires. The wires extend along an outside of the fan impeller 112 to be connected to the second circuit board 204 and is prevented from touching the fan impeller 112, such that the wires may not be scratched, and short circuits or poor contact are prevented. During assembly, a middle part of the wires is placed in the first wire channel 117, effectively utilizing a space. Due to an internal space being limited, a space is reserved, and the wires are prevented from damages during assembly.

Specifically, as shown in FIG. 10-5, the handheld portion 20 is arranged with a first connector 203. The airflow portion 10 is arranged with a second connector 105. The airflow portion 10 and the handheld portion 20 are connected to each other via a fixing member 131. The fixing member 131 passes through the first connector 203 and the second connector 105 to connect the airflow portion 10 with the handheld portion 20. A part of the handheld portion 20 is embedded in the airflow portion 10. By embedding the part of the handheld portion 20 in the airflow portion 10 and connecting the first connector 203 with the second connector 105 via the fixing member 131, overall stability of the handheld fan during use is ensured. For example, the fixing member 131 may be a screw or any other type of fixing member for connecting the airflow portion 10 with the handheld portion 20. A specific type of the fixing member is not limited herein.

Further, as shown in FIG. 10-6, an outer wall of the second inner shell 101 and an outer wall of the first inner shell 102 define a plurality of connecting grooves, and the plurality of connecting grooves are distributed along an axial direction. An inner wall of the outer shell 103 is arranged with a plurality of connecting protrusions 1031 corresponding to the connecting grooves. The connecting grooves and the connecting protrusions 1031 are mated with each other to guide the second inner shell 101 and the first inner shell 102 to be connected to the outer shell 103, and at the same time, rotation of the outer shell 103 with respect to the second inner shell 101 and the first inner shell 102 is prevented, connection stability of the second inner shell 101 and the first inner shell 102 being connected to the outer shell 103 is improved.

Specifically, the airflow portion 10 further includes an air inlet cover 104 covering the second inner shell 101. The air inlet cover 104 is arranged with a ring-shaped protrusion 1041 protruding towards an outside of the air inlet 161. A height of the protrusion is higher than a center 1042 of the air inlet cover 104. A gap is formed between the air inlet cover 104 and the fan impeller 112. By defining the gap between the air inlet cover 104 and the fan impeller 112, an air guiding effect is improved. For the air inlet cover 104 in the present embodiment, a plurality of connecting bars are arranged in a scattering pattern, scattering from a central axis towards an edged region, a gap is formed between every two adjacent connecting bars, the air inlet cover 104 has an opening. Each connecting bar is arc-shaped, and an opening of the arc-shaped connecting bar faces the fan impeller 112. By arranging the air inlet cover 104 formed from the arc-shaped connecting bars, a resistance during intaking the air is effectively reduced, improving the air intaking effect of the air inlet cover 104 and enhancing user experience. In other embodiments, the air inlet cover 104 defines a plurality of round, square, or other shaped holes.

Further, a display screen 122 is received in the receiving cavity 123, i.e., the display screen 122 is also connected to the fan base 111 and located on the side (referred to as a second side, which is the air outlet side, i.e., facing the air outlet 163 opposite to the first side where the fan impeller 112 is situated. The air outlet portion 121 surrounds a periphery of the display screen 122. While in use, the display screen 122 displays a fan speed level, a current air speed, and a battery power level. Please refer to FIGS. 10-5 and 10-7 together, a diameter of the display screen 122 is greater than the distance between the outer side of the fan base 111 and the inner side of the first inner shell 102. The distance between the outer side of the fan base 111 and the inner side of the first inner shell 102 is the radial distance of the air outlet portion 121. Specially, the distance between the outer side of the fan base 111 and the inner side of the first inner shell 102 is half of an amount of an inner diameter of the first inner shell 102 deducting a diameter of the display screen 122, and the diameter of the display screen 122 is greater than the amount of the inner diameter of the first inner shell 102 deducting the diameter of the display screen 122, i.e., the distance between the outer side of the fan base 111 and the inner side of the first inner shell 102 is less than a radius of the display screen 122.

Specifically, the second inner shell 101 is trapezoidal. A plurality of trapezoidal cavities 1011 are defined in an outer inclined surface of the second inner shell 101 and are spaced apart from each other. By defining the plurality of trapezoidal cavities 1011, vibration of the outer shell 103 caused by rotation of the fan impeller 112 is reduced, improving user experience.

Further, the handheld portion 20 further includes a bracket 201 and a battery 202 arranged inside the bracket 201. The battery 202 is electrically connected to the motor 113 and the display screen 122. While in use, the battery 202 supplies power to the motor 113 to drive the fan impeller 112 to rotate and operate and supplies power to the display screen 122 to display the remaining battery power level, the current air speed, and the battery level.

Specifically, please refer to FIGS. 10-6 to 10-8, a sleeve 132 is connected to the first side of the fan base 111 facing the second inner shell 101. The sleeve 132 is hollow, and the fan impeller 112 includes a hub 21 and a plurality of fan blades 22. The hub 21 is provided with a rotation shaft 23, which is inserted into the sleeve 132. The second inner shell 101 is closer to the first side relative to the first inner shell 102, and part of the fan impeller 112 is located inside the second inner shell 101, the fan blades 22 are located behind the connecting plate 1230, and the hub 21 has a radially increasing air guide surface 212 from the rear (air inlet side) to the front (air outlet side), and the diameter of the display screen 122 is greater than a greatest diameter of the hub 21, therefore the display screen 122 blocks the hub 21 from the air outlet side, and when viewed from the air outlet side, the hub 21 does not expose in the air outlet portion 121, and only a part of the fan blades 22 behind the connecting plate 1230 can be seen from the air outlet side.

The first side is equipped with a side wall and forms an avoiding space 1321 extending towards the rear and surrounded by the side wall. The fan impeller 112 has the motor 113, which includes a stator 31 and a rotor 32. The stator 31 is sleeved outside the sleeve 132, and the hub 21 includes an annular extension wall 211. The rotor 32 is accommodated in the extension wall 211, and the extension wall 211 extends into the avoiding space 1321.

Embodiment 11, referring to FIGS. 11-1 to 11-7:

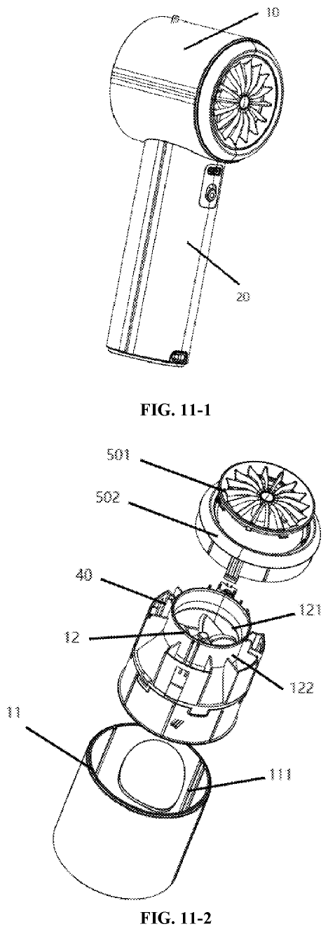

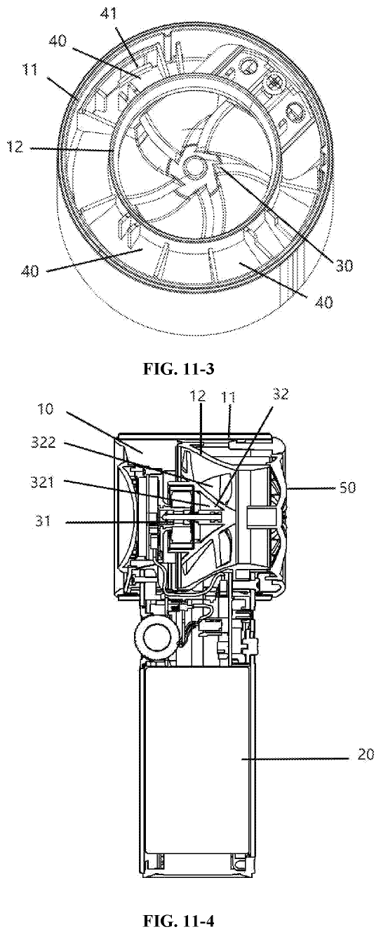

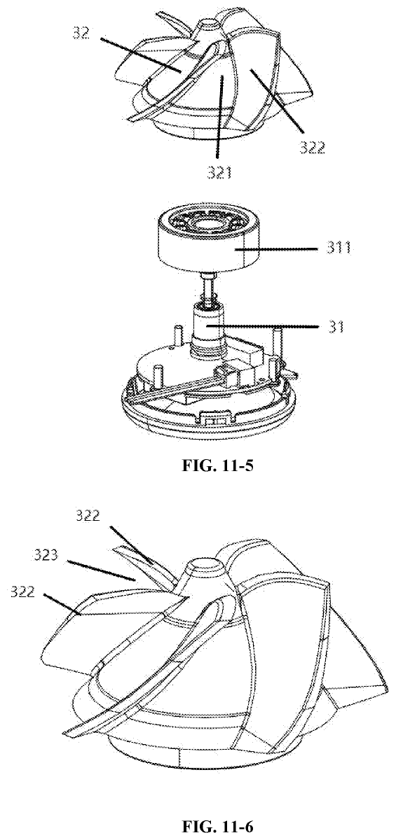

As shown in FIGS. 11-1 to 11-7, a handheld fan is provided, where vibration caused by the fan impeller during operation is reduced, and noise generated by the vibration transmitted to the housing is reduced. As shown in FIG. 11-1, the handheld fan includes an airflow portion 10 and a handheld portion 20. FIG. 11-2 is an exploded view of the handheld fan, wherein the airflow portion 10 includes an outer housing 11 and an inner housing 12 detachably connected to outer housing 11. The outer housing 11 defines a first receiving cavity 111 for receiving the inner housing 12, and the inner housing 12 defines a second receiving cavity 121 for receiving a airflow assembly 30. A vibration damping structure 40 is disposed between the outer housing 11 and the inner housing 12.

Specifically, the outer housing 11 and the inner housing 12 are detachably assembled with each other. The inner housing 12 is received in the first receiving cavity 111 of the outer housing 11, and the airflow assembly 30 is received in the second receiving cavity 121 of the inner housing 12. While using the handheld fan, rotation of the airflow assembly 30 causes vibration of the inner housing 12, and the vibration damping structure 40 disposed between the outer housing 11 and the inner housing 12 effectively reduces transmission of vibration from the inner housing 12 to the outer housing 11, such that noise while using the handheld fan is reduced.

Further, the vibration damping structure 40 is snap-fitted to an inner side of the outer housing 11 and is arranged around a periphery of the inner housing 12. In the present embodiment, the outer housing 11 and the inner housing 12 are detachably connected to each other, and the vibration damping structure 40 is snap-fitted to the inner side of the outer housing 11. The vibration damping structure 40 abuts against the inner side of the outer housing 11. In this way, the vibration generated in the inner housing 12 may be eliminated. Snap-fitting the vibration damping structure 40 to the inner side of the outer housing 11 facilitates easy disassembly, allowing the outer housing 11, inner housing 12, and the air inlet cover 50 to be cleaned conveniently.

Furthermore, the damping structure 40 is integrally formed with the inner housing 12, effectively reducing the transmission of vibration from the inner housing 12 to the outer housing 11 while the airflow assembly 30 is rotating. Furthermore, integral formation of the damping structure 40 and the inner housing 12 simplifies an overall structure of the handheld fan. Therefore, an assembling process of the handheld fan is simplified, improving a production efficiency.

Further, as shown in FIG. 11-3, showing a schematic view of the airflow portion, the vibration damping structure 40 includes at least two trapezoidal protrusions, and the at least two trapezoidal protrusions are spaced apart from each other with an equal interval. The number of the at least two trapezoidal protrusions is determined based on diameters of the outer housing 11 and the inner housing 12, which is not limited herein.

Specifically, in the present embodiment, the vibration damping structure 40 is configured as trapezoidal protrusions. A side of the trapezoidal having a wider cross section faces the outer housing 11, and a side of the trapezoidal having a narrower cross section faces the inner housing 12. The trapezoidal protrusions abuts against the inner side of the outer housing 11, effectively buffering the vibration transmitted from the inner housing 12 to the outer housing 11 while the airflow assembly 30 is rotating, such that a vibration damping effect is achieved.

Moreover, each trapezoidal protrusion is hollow, and an end of the trapezoidal protrusion snap-fitted to the outer housing 11 defines a through hole 41 for ventilation. The hollow trapezoidal protrusion reduces a weight of the trapezoidal protrusion, such that the handheld fan is lighter. Furthermore, hollow trapezoidal protrusion allows a certain space to be left for receiving elastic deformation during the outer housing 11 and the inner housing 12 rotating with respect to each other, enhancing stability of connection between the outer housing 11 and the inner housing 12. The through hole 41 defined in the end of the trapezoidal protrusion snap-fitted to the outer housing 11 ensures that the through hole 41 is not blocked while the vibration damping is achieved.

Further, FIG. 11-4 shows a cross-sectional view of the handheld fan of the present embodiment. The airflow portion 10 further includes an air inlet cover 50 snap-fitted to the inner housing 12. The air inlet cover 50 includes an air inlet plate 501 and a fixing ring 502 snap-fitted around a periphery of the air inlet plate 501. An air duct is formed between the air inlet plate 501 and the airflow assembly 30 and is located within the second receiving cavity 121.

Specifically, the airflow assembly 30 is received in the second receiving cavity 121. While the airflow assembly 30 is operating, air from the air inlet plate 501 is directed out of the second receiving cavity 121, such that the air duct is formed, the air is outputted more uniformly, and the air outputting efficiency of the handheld fan is improved.

Further, as shown in FIG. 11-5, FIG. 11-5 is a schematic view of the airflow assembly according to an embodiment of the present disclosure. The airflow assembly 30 includes a drive motor 31 and an impeller assembly 32. The impeller assembly 32 includes a conical cavity 321 and fan blades 322 arranged around a periphery of the conical cavity 321. A motor bearing 311 is received in the conical cavity 321 and sleeved an outside of the drive motor 31. The motor bearing 311 ensures stability of the drive motor 31 during high-speed rotation and ensuring the overall stability of the handheld fan during operation.

Specifically, in the present embodiment, when the user is using the handheld fan, the blades 322 is driven by the drive motor 31 to rotate, directing air from the air inlet cover 50 into the air duct inside the second receiving cavity 121 and outputting the air out of the fan through the air outlet. The user may direct the airflow to a desired body portion for rapid cooling, such that the usage experience is improved.

A maximum outer diameter of the impeller assembly 32 is smaller than a maximum outer diameter of the air inlet cover 50. In this way, most of the impeller assembly 32 is covered, a better appearance is provided, fingers or hair are prevented from being pinched, improving user experience. A maximum outer diameter of the outer housing 11 is equal to that of the air inlet cover 50,, ensuring a size of the air inlet cover 50 matching with a size of the outer housing 11, and ensuring stable and secure mounting.

Further, as shown in FIG. 11-6, FIG. 11-6 is a schematic view of the impeller assembly according to an embodiment of the present disclosure. The fan blades 322 are inclined, an inclined air duct 323 is formed between every two adjacent fan blades 322. The inclined air duct 323 guides the air from the air inlet cover 50 into the air duct. The inclined fan blades 322 increases a volume of the airflow, reduces noise, and the handheld fan may have a compact structure and is portable.

Further, as shown in FIG. 11-7, FIG. 11-7 is a schematic view of connection between the handheld portion and the airflow portion according to an embodiment of the present disclosure. The handheld portion 20 is arranged with a first connector 21, and the airflow portion 10 is provided with a second connector 13. The handheld portion 20 and the airflow portion 10 are connected via a fixing member 22. The fixing member 22 passes through the first connector 21 and the second connector 13 to fix the handheld portion 20 with the airflow portion 10. For example, the fixing member 22 may be a screw or any other type of fixing member for connecting the airflow portion 10 with the handheld portion 20, which will not be limited herein.

The handheld fan includes the airflow portion and the handheld portion. The airflow portion includes the outer housing and the inner housing detachably connected to the outer housing. The outer housing includes a first receiving cavity for receiving the inner housing, and the inner housing includes a second receiving cavity for receiving the airflow assembly. A vibration damping structure is disposed between the outer housing and the inner housing. While using the handheld fan, rotation of the airflow assembly causes vibration of the inner housing, and the vibration damping structure disposed between the outer housing and the inner housing effectively reduces transmission of vibration from the inner housing to the outer housing, such that noise while using the handheld fan is reduced, and the usage experience is improved.

Embodiment 12, referring to FIGS. 12-1 to 12-8:

As shown in FIGS. 12-1 to 12-8, a handheld fan is provided and has a small size and an ideal air outputting effect, and a high cooling efficiency is achieved.

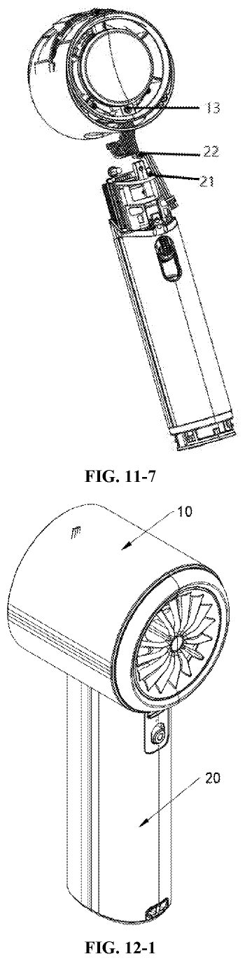

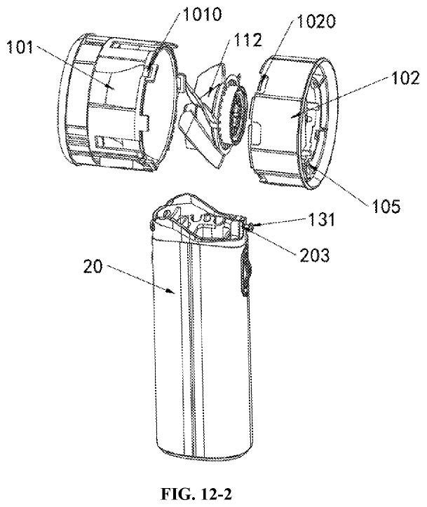

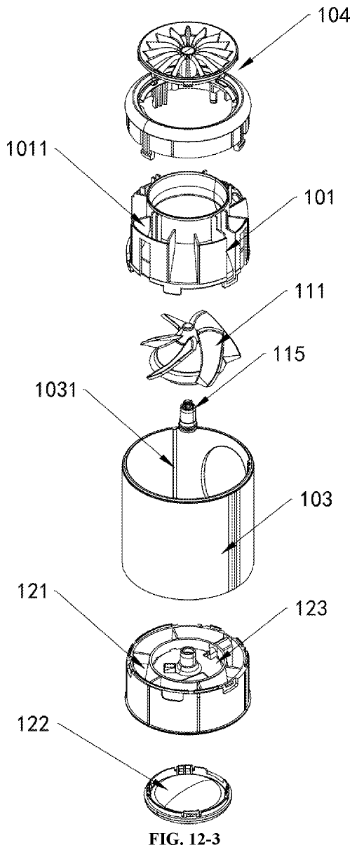

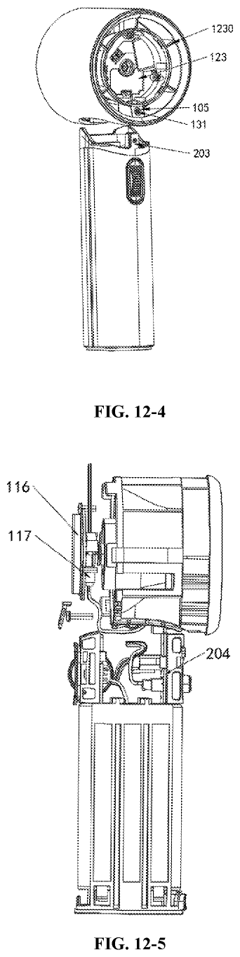

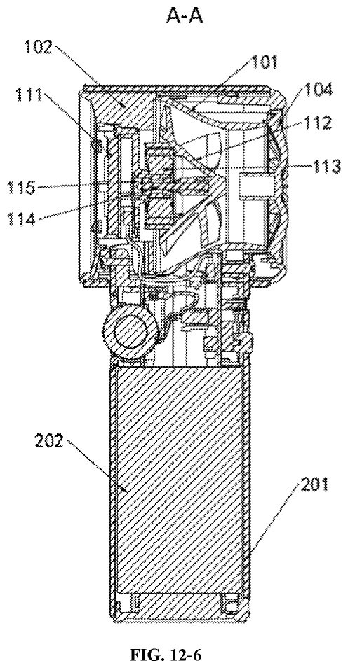

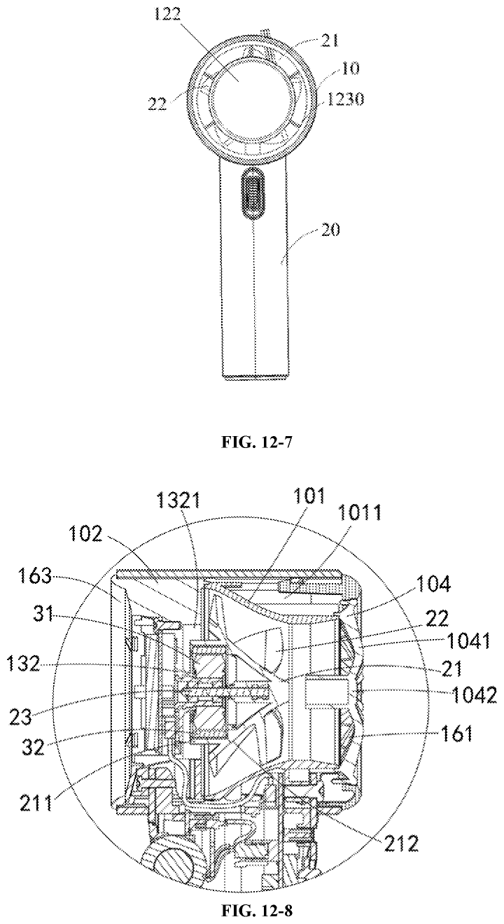

Specifically, as shown in FIG. 12-1, the handheld fan includes an airflow portion 10 and a handheld portion 20 detachably connected to the airflow portion 10. As shown in FIGS. 12-2 to 12-3, the airflow portion 10 includes a second inner shell 101 and a first inner shell 102 that is snap-fitted with second inner shell 101. The second inner shell 101 is disposed near an air inlet side, and the first inner shell 102 is disposed near an air outlet side. A fan base 111 is arranged inside the first inner shell 102, a fan impeller 112 is arranged on a side (referred to as a first side, the first side is also the air inlet side, i.e., facing towards the air inlet 161) of the fan base 111 facing the second inner shell 101. The fan impeller 112 is arranged inside the second inner shell 101. An end of the second inner shell 101 near the air inlet side extends beyond an end of the fan impeller 112 near the air inlet side. By arranging the fan impeller 112 inside the second inner shell 101 and arranging the end of the second inner shell 101 near the air inlet side to extend beyond the end of the fan impeller 112 near the air inlet side, an air intake channel is formed between the fan impeller 112 and the air inlet side, improving an air guiding efficiency. The fan impeller 112 is arranged inside the second inner shell 101, such that the intaken air may flow along the fan impeller 112 to be converged at the air outlet side to flow out of the fan, enhancing the air outputting effect of the handheld fan.

Further, the second inner shell 101 is a trapezoidal structure, and an outer inclined surface of the second inner shell 101 defines a plurality of trapezoidal cavities 1011 that are annularly distributed and are spaced apart from each other. A side of the second inner shell 101 facing the first inner shell 102 is arranged with a plurality of protrusions 1010 that are distributed evenly. The first inner shell 102 defines a plurality of recesses 1020 corresponding to the plurality of protrusions 1010. The trapezoidal cavities 1011 reduce overall vibration of the airflow portion 10 during rotation of the fan impeller 112, improving user experience. The protrusions 1010 and the recesses 1020 are tightly engaged with each other, such that the second inner shell 101 and the first inner shell 102 are tightly fastened to each other, and convenient assembling and disassembling between the second inner shell 101 and the first inner shell 102 can be achieved. By arranging the protrusions 1010 and the recesses 1020 to achieve assembling and disassembling between the second inner shell 101 and the first inner shell 102, disassembling and assembling for maintenance may be achieved easily, and the maintenance can be performed conveniently.

Specifically, the airflow portion 10 further includes an outer housing 103 sleeving the second inner shell 101 and the first inner shell 102. Outer walls of the second inner shell 101 and the first inner shell 102 define a plurality of connection grooves that are arranged along an axial direction. An inner wall of the outer housing 103 is arranged with a plurality of connection protrusions mated with the plurality of connection grooves. Mating between the connection grooves and the connection protrusions guides the second inner shell 101 and the first inner shell 102 to be connected to the outer housing 103, preventing the outer housing 103 from rotating relative to the second inner shell 101 and the first inner shell 102, and improving stability of the second inner shell 101 and the first inner shell 102 being connected to the outer housing 103.

Further, the fan impeller 112 includes a conical cavity, and a bearing 115 is received in the conical cavity. A motor rotation shaft 114 is inserted into the bearing 115 and connected to the bearing 113. The bearing 115 surrounds an outside of the motor rotation shaft 114. When the motor rotation shaft 114 rotates, the bearing 115 reduces axial deviation caused by rotation of the motor rotation shaft 114, ensuring stability of the motor shaft 114 during rotation and ensuring the overall stability of the handheld fan during operation.

Specifically, the airflow portion 10 further includes an air inlet cover 104 sleeving the second inner shell 101. The air inlet cover 104 includes an annular protrusion 1041 extending outwardly from the air inlet 161, a height of the protrusion is higher than a center 1042 of the air inlet cover 104. A gap is formed between the air inlet cover 104 and the fan impeller 112, improving an air guiding efficiency. For the air inlet cover 104 in the present embodiment, a plurality of connecting bars are arranged in a scattering pattern, scattering from a central axis towards an edged region, a gap is formed between every two adjacent connecting bars, the air inlet cover 104 has an opening. Each connecting bar is arc-shaped, and an opening of the arc-shaped connecting bar faces the fan impeller 112. By arranging the air inlet cover 104 formed from the arc-shaped connecting bars, a resistance during intaking the air is effectively reduced, improving the air intaking effect of the air inlet cover 104 and enhancing user experience. In other embodiments, the air inlet cover 104 defines a plurality of round, square, or other shaped holes.

Further, an air outlet portion 121 is arranged between an outer side of the fan impeller 112 and an inner side of the first inner shell 102, and a side of the fan base 111 defines a receiving cavity 123 receiving a display screen 122, i.e., the display screen 122 is also connected to the fan base 111 and located on the side (referred to as a second side, which is the air outlet side, i.e., facing the air outlet 163 opposite to the first side where the fan impeller 112 is situated. The air outlet portion 121 surrounds the display screen 122, and the display screen 122 displays a fan speed level, an air speed and a battery power level. Please refer to FIGS. 12-4 and 12-7 together, a diameter of the display screen 122 is greater than the distance between the outer side of the fan base 111 and the inner side of the first inner shell 102. The distance between the outer side of the fan base 111 and the inner side of the first inner shell 102 is the radial distance of the air outlet portion 121. Specially, the distance between the outer side of the fan base 111 and the inner side of the first inner shell 102 is half of an amount of an inner diameter of the first inner shell 102 deducting a diameter of the display screen 122, and the diameter of the display screen 122 is greater than the amount of the inner diameter of the first inner shell 102 deducting the diameter of the display screen 122, i.e., the distance between the outer side of the fan base 111 and the inner side of the first inner shell 102 is less than a radius of the display screen 122.

Specifically, an outer wall of the receiving cavity 123 is arranged with a plurality of connecting plates 1230 that are spaced apart from each other. The plurality of connecting plates 1230 are connected to an inner wall of the first inner shell 102, i.e., the connecting plates 1230 are arranged in the air outlet portion 121. By arranging the connecting plates 1230 between the outer wall of the receiving cavity 123 and the inner wall of the first inner shell 102, vibration, which is caused by operation of the motor 113 connected to the fan base 111, is reduced, such that stability of the fan base 111 during operation is improved, and the airflow driven by the fan impeller 112 blows out the air outlet 163 through the gap between each pair of adjacent connecting plates 1230.

Further, as shown in FIG. 12-4, the handheld portion 20 is arranged with a first connector 203, and the airflow portion 10 is arranged with a second connector 105. The airflow portion 10 and the handheld portion 20 are connected to each other via a fixing member 131. The fixing member 131 passes through the first connector 203 and the second connector 105 to secure the airflow portion 10 with the handheld portion 20. A part of the handheld portion 20 is embedded within the airflow portion 10. By embedding the part of the handheld portion 20 within the airflow portion 10 and connecting the first connector 203 with the second connector 105 via the fixing member 131, ensuring overall stability of the handheld fan while in use. For example, the fixing member 131 may be a screw or any other type of fixing member for connecting the airflow portion 10 with the handheld portion 20, which will not be limited herein.

Specifically, as shown in FIG. 12-5, a first circuit board 116 is arranged at a rear side of the fan base 111, the fan base 111 defines a first wire channel 117 in a radial direction thereof. A wire is led out from the first circuit board 116 to a second circuit board. The second circuit board 204 is arranged inside the handheld portion 20. In this way, wire arrangement can be performed easily. The first wire channel 117 ensures that the wire is not easily bent when connecting circuit boards, extending a service life of the wire. The wire extend along an outside of the fan impeller 112 to be connected to the second circuit board 204 and is prevented from touching the fan impeller 112, such that the wires may not be scratched, and short circuits or poor contact are prevented. During assembly, a middle part of the wires is placed in the first wire channel 117, effectively utilizing a space. Due to an internal space being limited, a space is reserved, and the wires are prevented from damages during assembly.

Further, as shown in FIG. 12-6, the handheld portion 20 further includes a bracket 201 and a battery 202 mounted inside the bracket 201. The battery 202 is electrically connected to the motor 113 and the display screen 122. While in use, the battery 202 supplies motor 113 to drive the fan impeller 112 to rotate and supplies power to the display screen 122 to display the remaining battery power level, the current air speed, and the battery power level.

Specifically, please refer to FIGS. 12-6 to 12-8, the fan base 111 is connected to a sleeve 132 on the side facing the second inner shell 101. The sleeve 132 is hollow, and the fan impeller 112 includes a hub 21 and a plurality of fan blades 22. The hub 21 is provided with a rotation shaft 23, which is inserted into the sleeve 132. The second inner shell 101 is closer to the first side relative to the first inner shell 102, and part of the fan impeller 112 is located inside the second inner shell 101, the fan blades 22 are located behind the connecting plate 1230, and the hub 21 has a radially increasing air guide surface 212 from the rear (air inlet side) to the front (air outlet side), and the diameter of the display screen 122 is greater than a greatest diameter of the hub 21, therefore the display screen 122 blocks the hub 21 from the air outlet side, and when viewed from the air outlet side, the hub 21 does not expose in the air outlet portion 121, and only a part of the fan blades 22 behind the connecting plate 1230 can be seen from the air outlet side.

The first side is equipped with a side wall and forms an avoiding space 1321 extending towards the rear and surrounded by the side wall. The fan impeller 112 has the motor 113, which includes a stator 31 and a rotor 32. The stator 31 is sleeved outside the sleeve 132, and the hub 21 includes an annular extension wall 211. The rotor 32 is accommodated in the extension wall 211, and the extension wall 211 extends into the avoiding space 1321.

The above embodiments only express some embodiments of the present disclosure, and the embodiments are described in details, but the description shall not be interpreted as a limitation of the scope of the present disclosure. It should be noted that, any ordinary skilled person in the art may perform various modifications and improvements without departing from the concept of the present disclosure, and the modifications and improvements shall belong to the scope of the present disclosure. Therefore, the scope of the present disclosure shall be subject to the appended claims.

What is claimed is:

1. A portable fan, comprising an airflow portion comprising an outer shell and a first inner shell received in the outer shell,
wherein a fan base and air outlet portion are arranged inside the first inner shell, and the air outlet portion is arranged between an outer side of the fan base and an inner side of the first inner shell, the fan base defining a first side and an opposite second side thereof, the first side facing towards an air inlet, the second side facing towards an air outlet, and the air outlet is in communication with the air outlet portion; and
wherein a fan impeller is connected to the first side of the fan base, a display screen is connected to the second side of the fan base, and a diameter of the display screen is greater than a distance between the outer side of the fan base and the inner side of the first inner shell.

2. The portable fan according to claim 1, wherein a hollow sleeve is connected to the first side of the fan base, the fan impeller comprises a hub, the hub is provided with a rotation shaft inserted into the sleeve, thereby the fan impeller is connected to the first side of the fan base.

3. The portable fan according to claim 2, wherein the first side is equipped with a side wall and forms an avoiding space extending towards the air inlet and surrounded by the side wall;
the fan impeller further comprises a motor comprising a stator and a rotor, the stator is sleeved outside the sleeve, and the hub includes an annular extension wall, the rotor is accommodated in the extension wall, and the extension wall extends into the avoiding space.

4. The portable fan according to claim 1, wherein a side of the fan base comprises a receiving cavity, and the air outlet portion is arranged between an outside of the receiving cavity and the inner side of the first inner shell;
a display screen is received in the receiving cavity, and the air outlet portion surrounds a periphery of the display screen.

5. The portable fan according to claim 4, wherein the display screen displays a fan speed level, a current air speed, and a battery power level.

6. The portable fan according to claim 4, wherein a plurality of spaced connecting plates are arranged between an outer wall of the receiving cavity and an inner wall of the first inner shell, and an airflow driven by the fan impeller blows out the air outlet through a gap between each two adjacent of the connecting plates.

7. The portable fan according to claim 1, further comprising a handheld portion detachably connected to the airflow portion, wherein a first circuit board is arranged at the fan base, a second circuit board is arranged at the handheld portion; and
the fan base comprises a first wire channel defined a radial direction thereof, the first wire channel is configured to receive wires connecting from the first circuit board to the second circuit board.

8. The portable fan according to claim 1, further comprising a second inner shell, wherein the first inner shell is engaged with the second inner shell, the second inner shell is also received in the outer shell, and the second inner shell is closer to the first side relative to the first inner shell, and part of the fan impeller is received in the second inner shell.

9. The portable fan according to claim 8, wherein a side of the second inner shell facing the first inner shell is arranged with a plurality of protruding structures, the first inner shell defines a plurality of recessed structures corresponding to the plurality of protruding structures, the protruding structures are engaged with the recessed structures correspondingly.

10. The portable fan according to claim 8, wherein an outer wall of the second inner shell and an outer wall of the first inner shell define a plurality of connecting grooves, an inner wall of the outer shell is arranged with a plurality of connecting protrusions corresponding to the connecting grooves, the connecting grooves and the connecting protrusions are matched with each other to guide the second inner shell and the first inner shell to be connected to the outer shell.

11. The portable fan according to claim 8, wherein the second inner shell is trapezoidal, and a plurality of trapezoidal cavities are defined in an outer inclined surface of the second inner shell and are spaced apart from each other.

12. The portable fan according to claim 8, wherein the airflow portion further includes an air inlet cover covering the second inner shell, the air inlet cover is arranged with a ring-shaped protrusion protruding towards an outside of the air inlet, a height of the protrusion is higher than a center of the air inlet cover.

13. The portable fan according to claim 1, wherein the distance between the outer side of the fan base and the inner side of the first inner shell is half of an amount of an inner diameter of the first inner shell deducting a diameter of the display screen, and the diameter of the display screen is greater than the amount of the inner diameter of the first inner shell deducting the diameter of the display screen.

14. The portable fan according to claim 1, wherein the fan impeller comprises a hub, a diameter of the display screen is greater than a greatest diameter of the hub, therefore the display screen blocks the hub from the second side.

15. A portable fan, comprising an airflow portion comprising a fan impeller, a first inner shell and an outer shell, the fan impeller and the first inner shell are received in the outer shell,
wherein a fan base and air outlet portion are arranged inside the first inner shell, and the air outlet portion is arranged between an outer side of the fan base and an inner side of the first inner shell, the fan base defining a first side and an opposite second side thereof, the first side facing towards an air inlet, the second side facing towards an air outlet, and the air outlet is in communication with the air outlet portion; and
wherein a hollow sleeve is connected to the first side of the fan base, and the fan impeller comprises a hub, the hub is provided with a rotation shaft inserted into the sleeve, and a display screen is connected to the second side of the fan base.

16. The portable fan according to claim 15, wherein a diameter of the display screen is greater than a distance between the outer side of the fan base and the inner side of the first inner shell.

17. The portable fan according to claim 16, wherein the distance between the outer side of the fan base and the inner side of the first inner shell is half of an amount of an inner diameter of the first inner shell deducting a diameter of the display screen, and the diameter of the display screen is greater than the amount of the inner diameter of the first inner shell deducting the diameter of the display screen.

18. The portable fan according to claim 16, wherein the fan impeller comprises a hub, a diameter of the display screen is greater than a greatest diameter of the hub, therefore the display screen blocks the hub from the second side.

19. A portable fan, comprising an airflow portion comprising a first inner shell, a second inner shell and an outer shell, wherein the first inner shell is engaged with the second inner shell, and the first inner shell and the second inner shell are received in the outer shell;
wherein a fan base and air outlet portion are arranged inside the first inner shell, and the air outlet portion is arranged between an outer side of the fan base and an inner side of the first inner shell, the fan base defining a first side and an opposite second side thereof, the first side facing towards an air inlet, the second side facing towards an air outlet, and the air outlet is in communication with the air outlet portion; and
wherein a fan impeller is connected to the first side of the fan base, a display screen is connected to the second side of the fan base, and part of the fan impeller is located at the second inner shell.

20. The portable fan according to claim 19, wherein a hollow sleeve is connected to the first side of the fan base, the fan impeller comprises a hub, the hub is provided with a rotation shaft inserted into the sleeve.
